(19) United States
(12) Patent Application Publication
(10) Pub. No.: US 2017/0243244 A1
(43) Pub. Date: Aug. 24, 2017

(54) Methods Circuits Devices Systems and Associated Machine Executable Code for Taste-based Targeting and Delivery of Content

(71) Applicant: JINNI MEDIA LTD., Hod HaSharon (IL)

(72) Inventors: Yohai Trabelsi, Ashkelon (IL); Mordechai Mori Rimon, Jerusalem (IL); Izhak Ben-Zaken, Shimshit (IL); Ori Assaraf, Hod HaSharon (IL)

(21) Appl. No.: 15/590,040

(22) Filed: May 9, 2017

Related U.S. Application Data
(63) Continuation-in-part of application No. 15/466,973, filed on Mar. 23, 2017.
Application No. 15/466,973 is a continuation-in-part of application No. 13/872,115, filed on Apr. 28, 2013.
Application No. 13/872,115 is a continuation-in-part of application No. 12/859,248, filed on Aug. 18, 2010.
(60) Provisional application No. 62/333,291, filed on May 9, 2016.
(60) Provisional application No. 61/234,817, filed on Aug. 18, 2009.

(51) Int. Cl. G06Q 30/02; H04N 21/258; H04N 21/45; H04N 21/81; H04N 21/442

(52) U.S. Cl. CPC G06Q 30/0242; G06Q 30/0271; G06Q 30/0277; H04N 21/812; H04N 21/44222; H04N 21/4532; H04N 21/25891

(57) ABSTRACT

Disclosed is a digital content targeting and delivery system. The system includes an interface to receive a primary content for distribution to one or more audience groups and a content feature detector to extract content features relevant to each of one or more audience groups. A relevant audience set generator parses a pool of potential audience member records into one or more (target) audience group lists by matching extracted content features with content preference parameters/fields of taste user profiles within the potential audience member records. a derivative content delivery module delivers, to members of at least one audience group, a derivative of the primary content including content segments with content features matching at least one common preference of the members of the at least one audience group.

### RELATED APPLICATIONS

This application claims the priority of applicant's U.S. Provisional Patent Application No. 62/333,291, filed May 9, 2016. This application is also a continuation-in-part of applicant's U.S. patent application Ser. No. 15/466,973, filed Mar. 23, 2017, which is a continuation-in-part of applicant's U.S. patent application Ser. No. 13/872,115, filed Apr. 28, 2013, which is a continuation-in-part of U.S. patent application Ser. No. 12/859,248, filed Aug. 18, 2010, which claims priority from U.S. Provisional Patent Application No. 61/234,817, filed Aug. 18, 2009. The disclosures of all of the above mentioned: 62/333,291, Ser. Nos. 15/466,973, 13/872,115, 12/859,248 and 61/234,817 patent applications, are hereby incorporated by reference in their entirety for all purposes.

### FIELD OF THE INVENTION

The present invention generally relates to the field of internet user profiling, and crowd/audience targeting based thereof, and more particularly, to methods, circuits, devices, systems and associated computer executable code for taste-based targeting and delivery of content.

### BACKGROUND

E-commerce and marketing firms have taken advantage of profiling for years by collecting volumes of information on individuals. Such profiling is accomplished by aggregating information on individuals purchase history (online and offline), finance records, magazine sales, supermarket savings cards, surveys, and sweepstakes entries, just to name a few. This information is then cleaned, organized, and analyzed using a number of statistical and data mining techniques to create a “shopping” profile of that individual. These profiles can then be used to target ad campaigns, personalize a shopping experience, or make recommendations on additional products a user may find appealing.

A range of technologies and techniques used by online website publishers and advertisers are aimed at increasing the effectiveness of advertising using user web-browsing behavior information. Information is collected from an individual's web-browsing behavior (e.g. the pages that they have visited or searched) to match content or select advertisements to display.

When a user visits a web site, the pages they visit, the amount of time they view each page, the links they click on, the searches they make and the things that they interact with, allow sites to collect that data, and other factors, create a ‘profile’ that links to that visitor (e.g. to visitor's web browser). This type of data may be used to create defined audience segments based upon visitors having substantially similar profiles, wherein defined audience segments may be utilized for targeted advertising.

Targeted advertising is a type of advertising whereby advertisements are placed so as to reach consumers based on various traits such as demographics, psychographics, behavioral variables (such as product purchase history), or other second-order activities which serve as a proxy for these traits.

Most targeted new media advertising currently uses second-order proxies for targeting, such as tracking online or mobile web activities of consumers, associating historical webpage consumer demographics with new consumer web page access, using a search word as the basis for implied interest, or contextual advertising.

Behavioral targeting is one of the most common targeting methods used online. Behavioral targeting works by anonymously monitoring and tracking the content read and sites visited by a user or IP when that user surfs on the Internet. This is done by serving tracking codes. Sites visited, content viewed, and length of visit are databased to predict an online behavioral pattern.

Alternatives to behavioral advertising may include audience targeting, contextual targeting, and psychographic targeting.

The distinctions made by demographic, psychographic and behavioral models, however, are coarse and often fail to predict a fit in some specific domain (e.g. two New Yorkers at their thirty-something years who regularly visit the CNN website, Amazon and Google maps, may still have completely different preferences in movies and TV shows).

Accordingly, there remains a need, in the fields of Online Behavioral Analysis and Internet User Profiling, for solutions facilitating taste-profiling of Internet/Network users, wherein taste-profiling is at least partially based on monitored web-browsing of users, and/or on other type, or combination of types, of monitored user interaction with a computerized device and/or an online/networked computerized device; and, the generation of: domain specific semantic user taste profiles (e.g. an Entertainment specific taste profile towards movie and TV content), crowds/audiences specific target segments and/or targeted advertising-campaigns/content-delivery based thereof.

### SUMMARY OF THE INVENTION

The present invention includes methods, circuits, devices, systems and associated machine executable code for content targeting and delivery. According to some embodiments, there may be provided an automated system for targeting a specific content item towards a dynamically selected audience group, wherein the dynamically selected group is compiled based on receptiveness of group members to one or more attributes of the specific content item.

Content items may be representative of (e.g. advertisement for) an offering, such as content (e.g. a movie), a good, a service and/or a cause (e.g. Greenpeace). According to embodiments, several different content items may be representative of the same offering. Each of one or more content items, for the same or for different offerings, may be targeted towards a separate respective audience group, wherein a specific content item and a specific group may be matched based on an affinity of group members of the specific group towards attributes of the specific content item.

According to further embodiments of the present invention, the system may dynamically generate one or more audience groups, from a pool of potential audience members, by: (1) identifying a set of content attributes (e.g. in form of attribute vectors) of the content item; and (2) searching data records in a database of audience pool member records, which records include individual member targeting identifiers with associated content preferences (optionally in the form of a semantic taste profile, for example—as described in applicant's U.S. patent application Ser. No. 15/466,973, which is incorporated hereto by reference), for members whose content preferences match, correspond or otherwise correlate to as least some of the content item's content attributes.

According to some embodiments, multiple audience groups may be generated for a given content item with a substantially large set of content attributes, wherein each group is associated with a different combination of attributes.

The system according to some embodiments of the present invention may also deliver a content item to members of one or more audience groups matching the content item attributes, directly or through a third party network, using the member identifiers.

According to some embodiments, targeted content items may include: media/entertainment content—movies, TV shows and series, recorded/live shows, events and performances; trailers—movie trailers, TV trailers, previews, promos, sports/news updates; and/or advertisements—any promotional content, commercial content and/or content representative of an offering.

According to some embodiments, a given targeted secondary content item (e.g. a movie trailer), inherently associated with a corresponding primary content item (e.g. the movie of the trailer) may be targeted at least partially based on the matching of attributes of the primary content item to audience pool members' attributes.

According to some embodiments, targeted content items may be representative of an offering. Content items representing offerings may include: (1) trailers or previews, informing of and presenting to members of a targeted audience group, highlights or climaxes which are part of, or are associated with, another, primary, content item or set of content items (e.g. a movie, a TV series, a sports/cultural event) offering members of the targeted audience group to consume the primary content (e.g. visit cinema, watch TV series on Netflix, go to a football-game/live-show or watch it online); (2) advertisements or promotions, interesting members of a targeted audience group in specific goods, services and/or causes and offering/convincing members to: purchase, subscribe, donate/contribute and/or recommend or offer to others the goods, services and/or causes, represented in the offering of the content item(s).

According to some embodiments of the present invention, content item attributes may include a set of tastes representing the content item (title). The set of tastes representing the content item may be identified/generated by: (1) creating a repository of prototypical tastes based on key genes from existing taste profiles of a substantially large set of end users—wherein ‘genes’ are part of a ‘Genome’ consisting of a pre-defined structured taxonomy of domain-specific (e.g. media domain, entertainment domain) content features/characteristics, structured in categories (e.g. content categories), and degreed by salience scores and/or confidence measures, wherein each such feature/characteristic may be referred to as a ‘Gene’; (2) tagging the content item with genes by classifying it against a genome or a subset thereof; (3) ranking the matching level of genes of each, or each of a subset, of the prototypical tastes to genes of the tagged content items; and (4) selecting one or more highest scoring (best matching) tastes from the prototypical repository as the attributes of the content items.

According to some embodiments, members of an audience group for a given targeted content item may be selected from within an audience pool, at least partially based on the level of matching of the tastes included in each of the member's taste profiles, to the highest scoring (best matching) tastes selected as the given content item's attributes.

According to some embodiments, a content item, or content item version, representing an offering, may be selected from within a set of two or more content items/versions representing the same offering (e.g. different angles/attribute-sets/emphasis).

The levels of matching of tastes included in each, or in a subset, of the pool member's taste profiles, to the tastes selected as the content item's attributes, for each of the content items/versions representing the same offering, may be calculated. The levels of matching may be calculated by applying a semantic similarity/distance function between each taste of a user's taste profile and the tastes selected as the attributes of the content item (e.g. the advertised title), the function may take into account, at least: the confidence level of each taste, weights for different types of content categories, the salience of each gene in the given content item(s), the frequency of each gene in an entire content catalog, and/or relations between genes. A weighted aggregated score for the entire user's/pool-member's taste profile based on the similarity/distance between each taste of the user's/pool-member's taste profile and the profile of the advertised title.

Content item(s), content item(s) version(s) and/or content item(s) derivative(s), receiving the highest matching levels scores (e.g. overall, average) to pool member's taste profiles, or content items/versions which yielded the largest pool members group having matching tastes (appeals to the largest crowd segment), may be selected for representing the offering.

According to some embodiments, upon generation of a pool members group having a number of members which is below a predefined, or aspired, threshold number, the system may: (1) lower one or more matching level conditions for inclusion in the pool members group; and/or (2) while considering their relative relevance to different members groups —move members from a pool members group, having a number of members which is above the predefined threshold, into a relatively relevant pool members group also having a number of members which is below the predefined threshold.

Pool members group(s) having a specific aspired or predefined number—maximal, minimal, or range—of members, may be generated by tuning one or more matching level conditions for inclusion in the respective pool members group(s).

According to some embodiments, multiple content items, or content item versions, may be selected from within a set of two or more content items/versions representing the same offering (e.g. different angles/attribute-sets/emphasis), wherein: (1) each of the selected items/versions better matches a different member group from within the audience pool; and/or (2) each of the selected items/versions yields a substantially large audience pool member group and the yielded substantially large pool member groups are strange to, or only partially overlap, each other.

According to some embodiments, taste profiles of audience pool members may each be associated with a member identifier. A content item targeted towards a specific matching audience group may be forwarded/delivered, directly or through a third party network, to audience group members based on their corresponding identifiers in the audience pool, optionally retrieved as part of the audience group's generation.

A system in accordance with some embodiments, may facilitate ad-space bidding/pricing, wherein prices are set based on system computed matching level, or matching confidence, in the matching of a content-item (e.g. an ad), or attributes thereof, to taste profile attributes of specific users/members, user groups and user segments.

According to some embodiments, bids or offers for forwarding/delivering and presenting a given content item (e.g. an ad) at a specific location, for example a specific area of a given website's page, may be calculated at least partially based on the matching level of the attributes of the given content item to the attributes of taste profiles of pool members which: visited and/or are currently visiting the specific location; and/or had or are currently having engagement or interaction with data at the specific location.

The higher the matching level of the specific location associated pool members' attributes to the attributes of the given content item is, the higher the value of the bid or offer will be. Accordingly, multiple presentations of the same content item at different locations (e.g. web-places), websites, webpages, times, and/or to different users, may each trigger the generation of a corresponding differently priced bid.

A system in accordance with some embodiments, may facilitate customized content item generation for given/pre-defined/dynamically-generated targeted members groups. According to some embodiments, content items may consist of multiple segments (e.g. video trailer subdivisions), wherein for each of the multiple segments of a given content item, the system may store one or more alternatives each providing a different perspective and/or emphasis.

For each content item segment, the matching level of attributes of each of the segment alternatives to the attributes of taste profiles of a specific targeted members group may be computed. The process may be repeated for each of the segments collectively forming the content item.

A customized content item may be automatically generated, in accordance with some embodiments, wherein the generated content item consists of segment alternatives best (or highly) matching the specific targeted members group, for each or all of the segments collectively forming the content item.

According to some embodiments, multiple customized content item versions, each having a similar segment structure but including different alternative content item segment selections for at least some of their segments, may be automatically generated by the system for multiple respective socioeconomic given/pre-defined/dynamically-generated member groups.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram of an exemplary system for content item targeting and delivery, in accordance with some embodiments of the present invention;

FIG. 1B is a block diagram of an exemplary system for content item targeting and delivery including a derivative content generator, in accordance with some embodiments of the present invention;

FIG. 10 is a block diagram of an exemplary system for content item targeting and delivery including a derivative content selector, in accordance with some embodiments of the present invention;

FIG. 2 is a block diagram showing in further details an exemplary system for content item targeting and delivery, including: servers, module blocks, logics and databases thereof, in accordance with some embodiments of the present invention;

FIG. 3 is a block diagram showing an exemplary Title/Item Tagging and Taste Profiling Server, in accordance with some embodiments of the present invention;

FIG. 4 is a flowchart showing the main steps of an exemplary process for Automatic creation of a repository of prototypical tastes, executed by a prototypical tastes repository generator, in accordance with some embodiments of the present invention;

FIGS. 5A-5C are diagrams associated with an exemplary process of Automatic creation of a repository of prototypical tastes, in accordance with some embodiments of the present invention, wherein: FIG. 5A shows an exemplary set of tastes, selected, from within semantic user taste profile(s); FIG. 5B shows an exemplary clustered set of movie title content-items; and FIG. 5C shows an exemplary taste appearing with a relatively high level of confidence in a normalized/averaged vector, representing titles;

FIG. 6 is a flowchart showing the main steps of an exemplary process for Automatic tagging of a content item or title to identify its most relevant genes, executed by a content item tagger, in accordance with some embodiments of the present invention;

FIG. 7 is a diagram associated with the process of Automatic tagging of a content item or title to identify its most relevant genes, in accordance with some embodiments of the present invention, showing an exemplary input text from a textual source review utilized as one of the sources of linguistic features for gene mapping;

FIG. 8 is a flowchart showing the main steps of an exemplary process for Ranking prototypical tastes from the repository vis-à-vis content item or title, executed by a content item prototypical tastes ranking logic, in accordance with some embodiments of the present invention;

FIGS. 9A-9B are diagrams associated with the process of Ranking prototypical tastes from the repository vis-à-vis content item or title, in accordance with some embodiments of the present invention, wherein: FIG. 9A shows a first exemplary matching score calculation; and FIG. 9B shows a second exemplary matching score calculation;

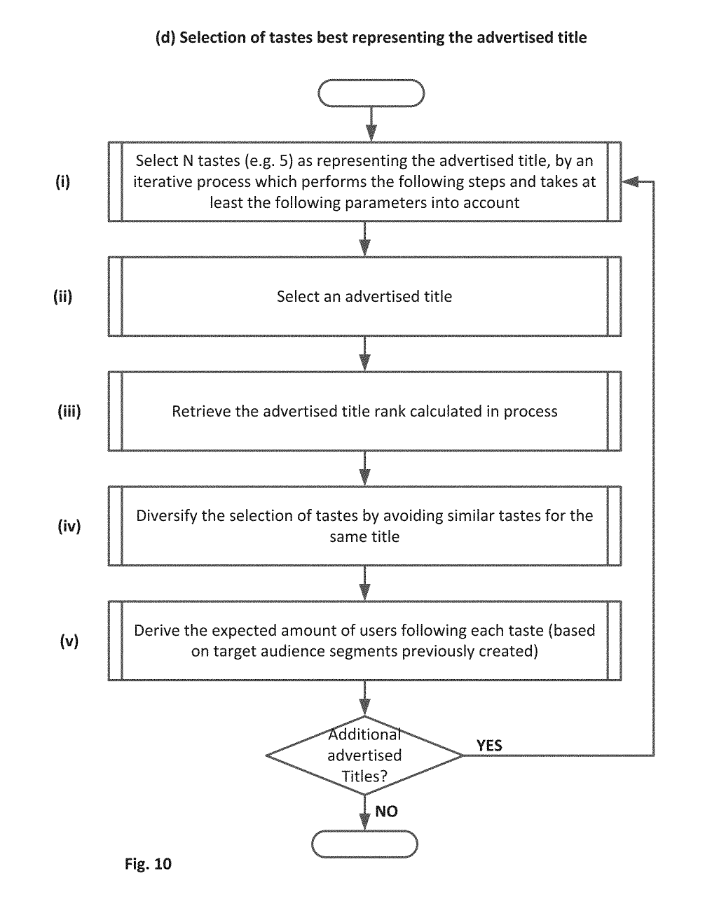

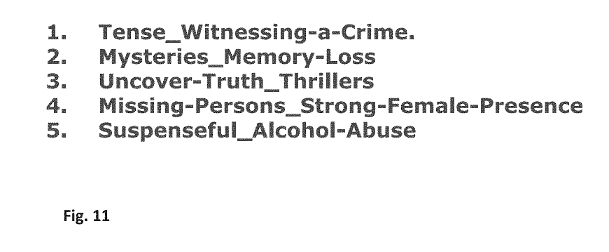

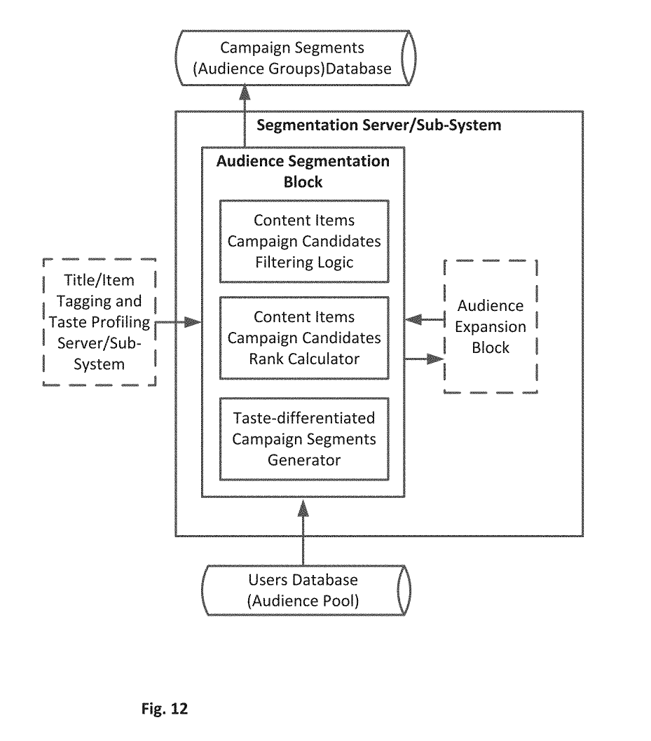

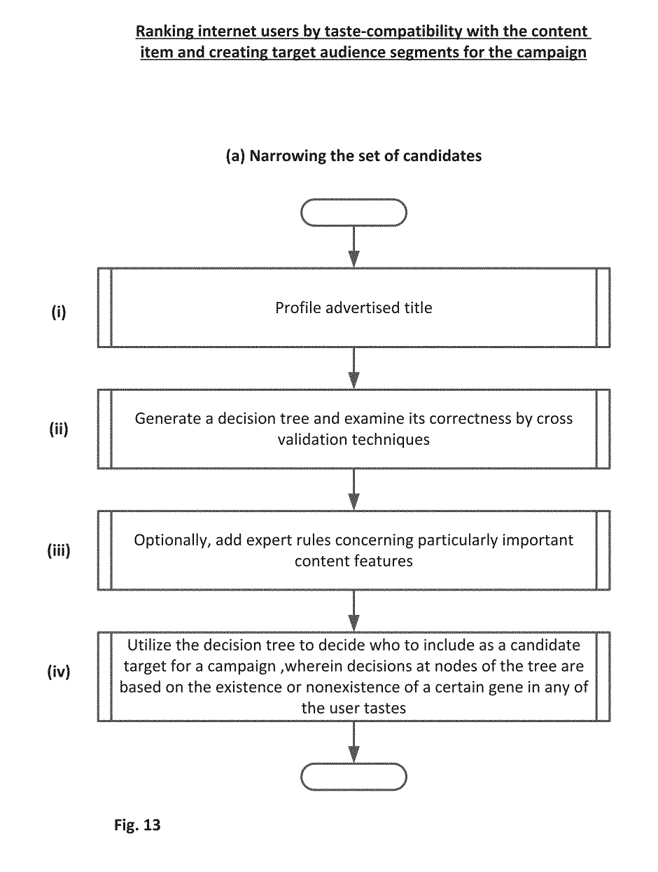

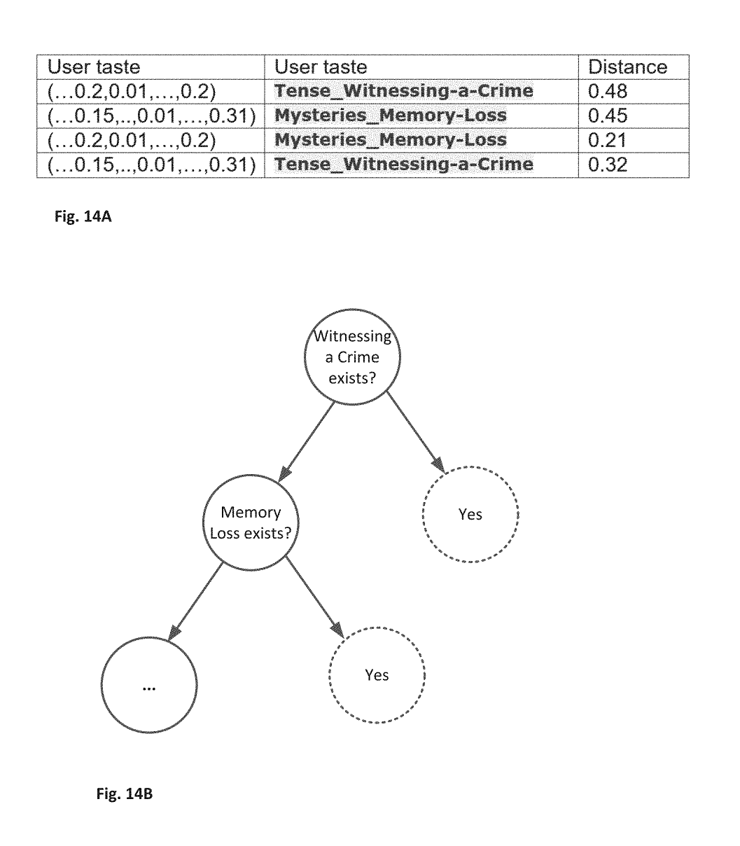

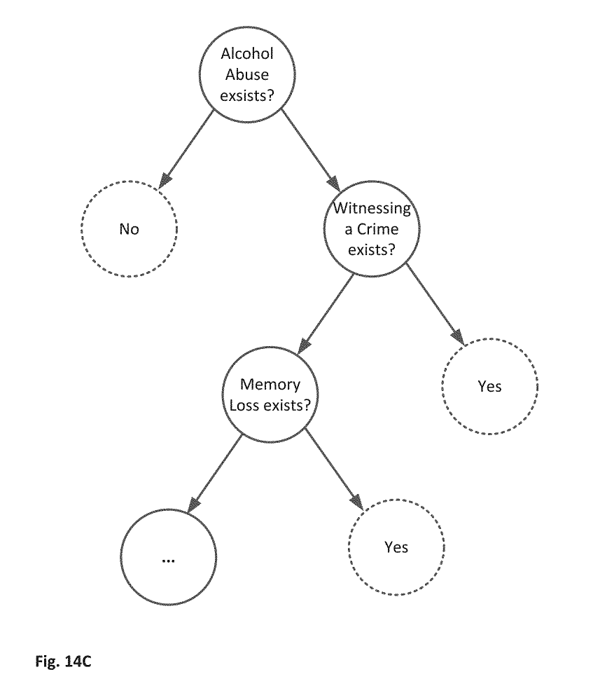

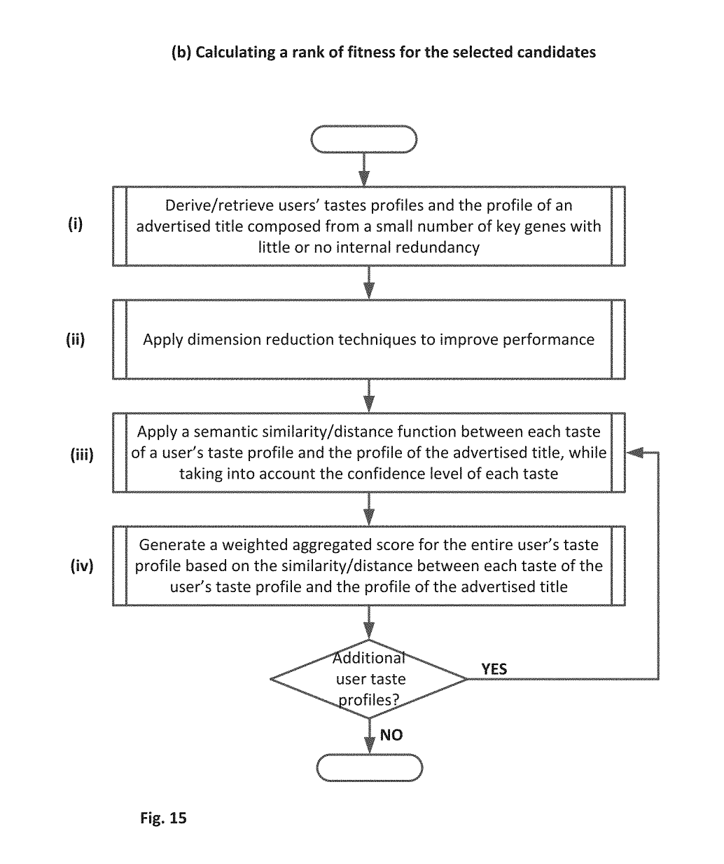

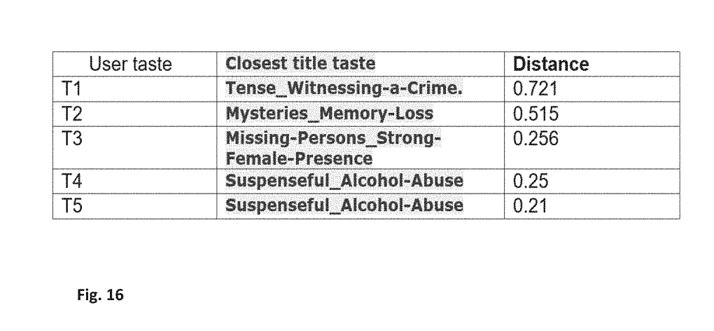

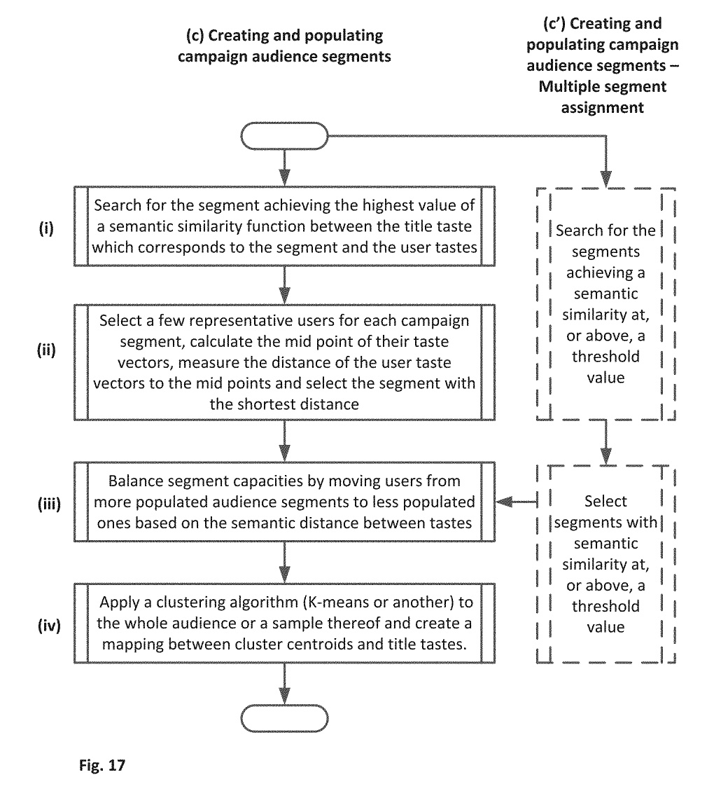

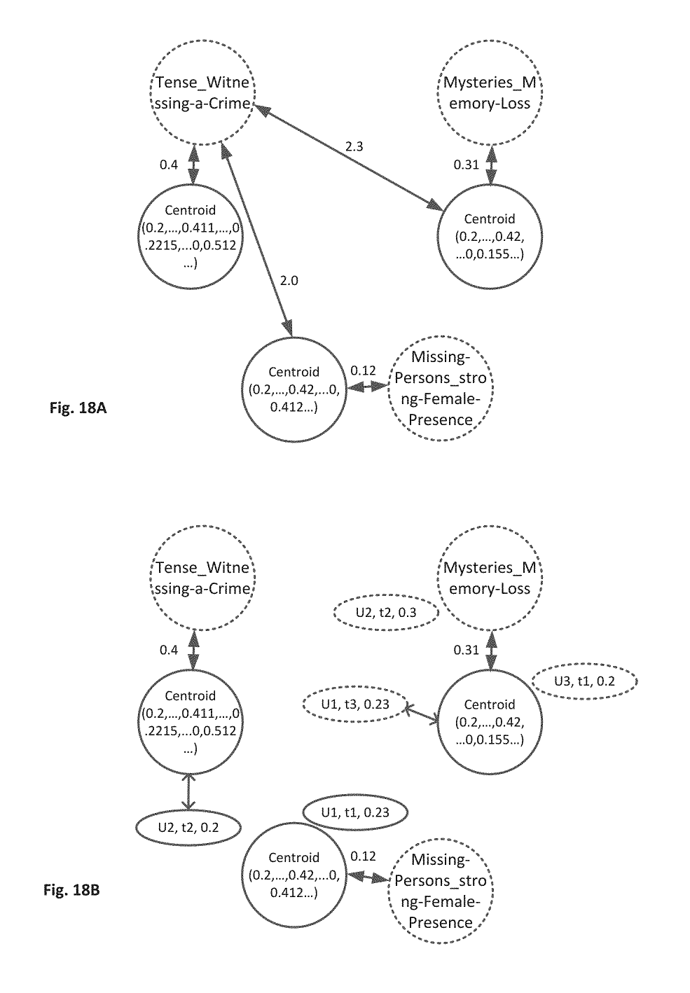

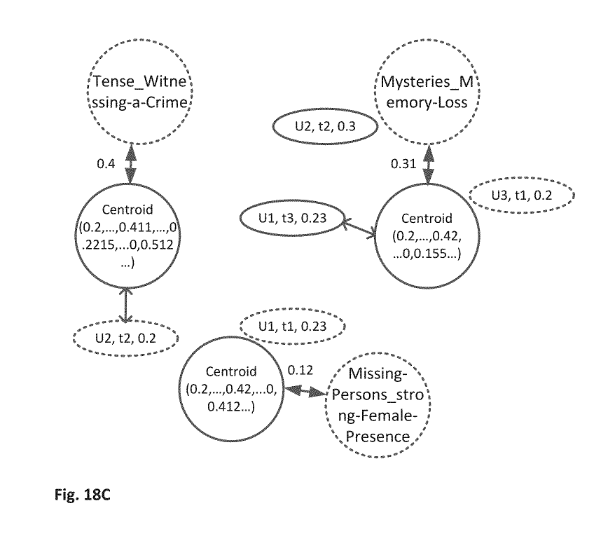

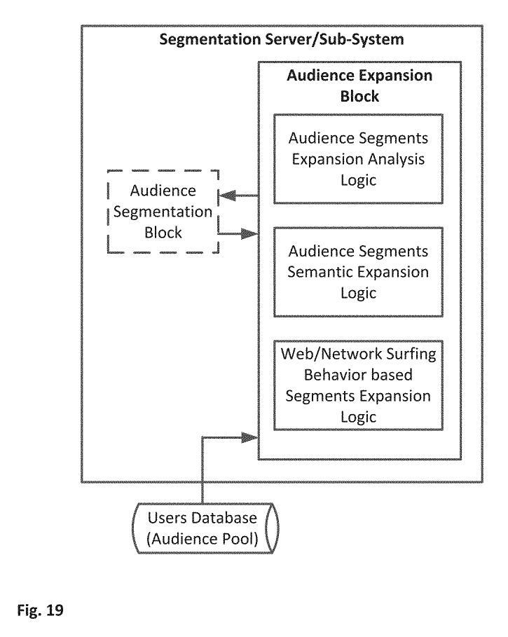

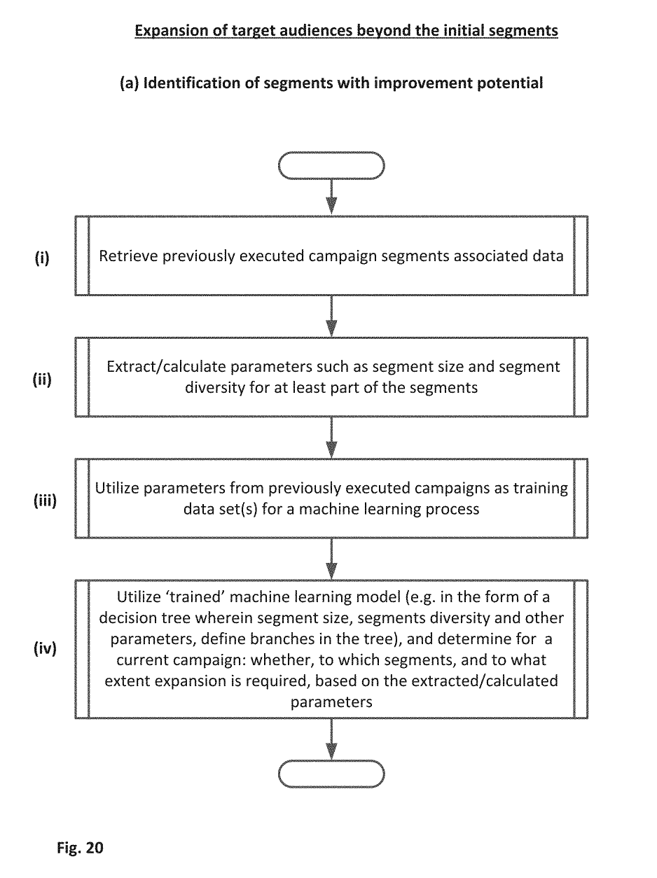

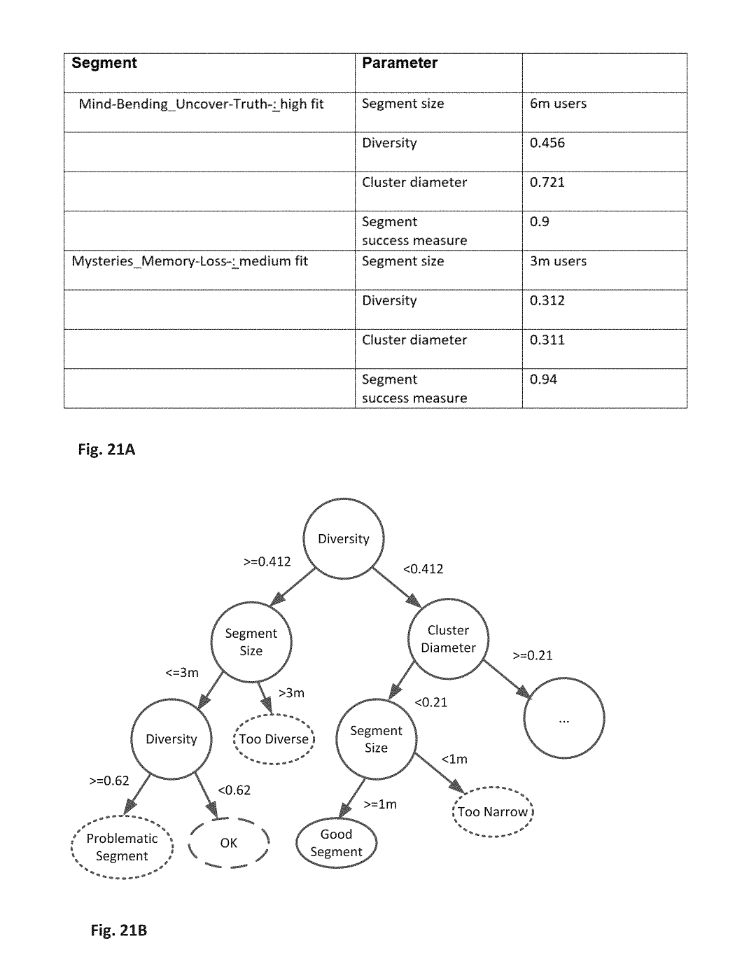

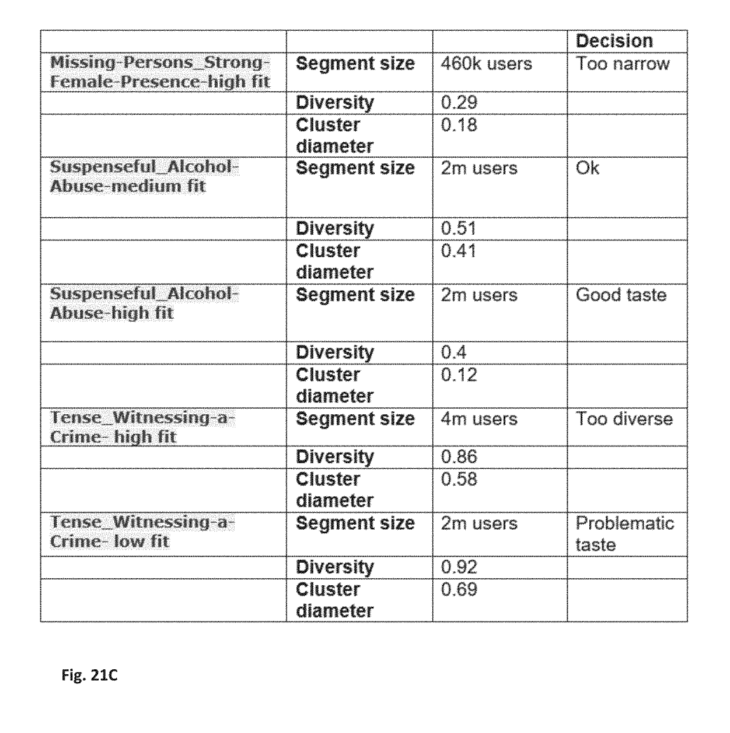

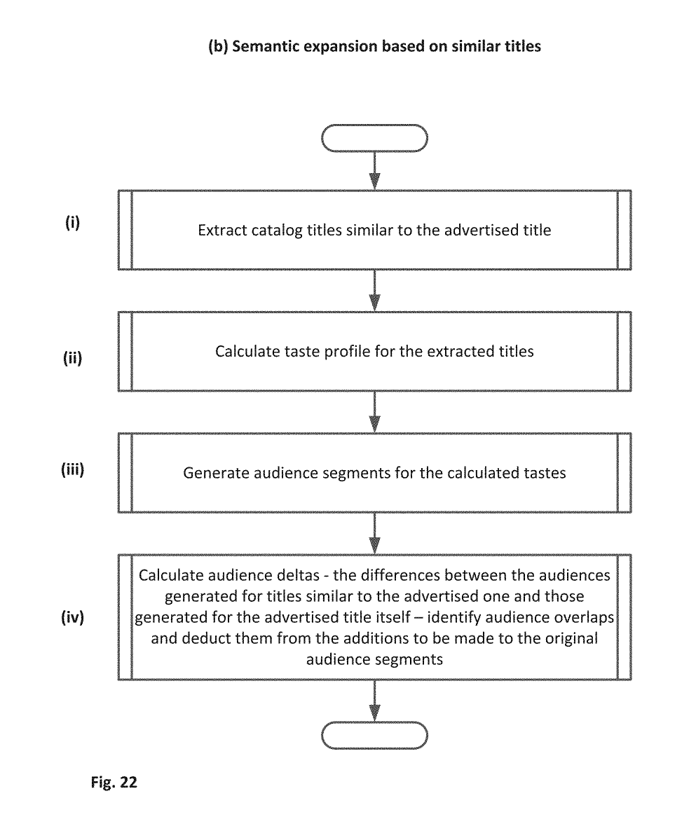

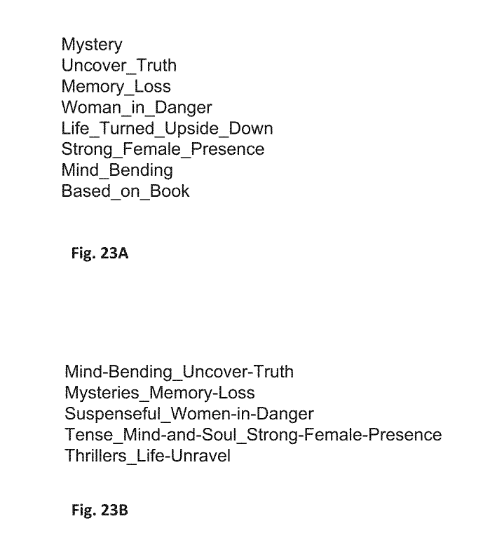

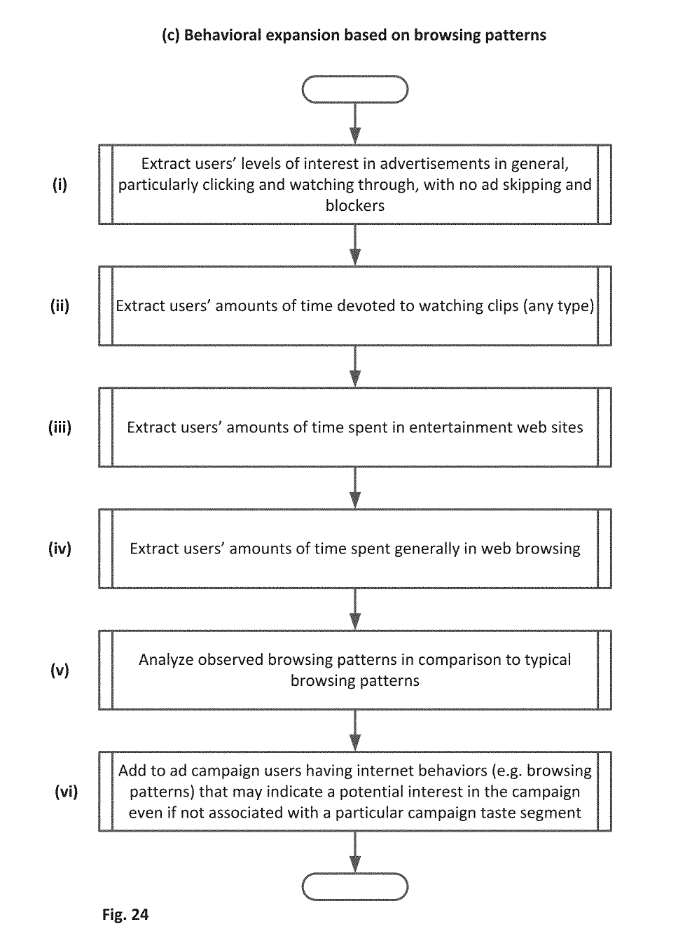

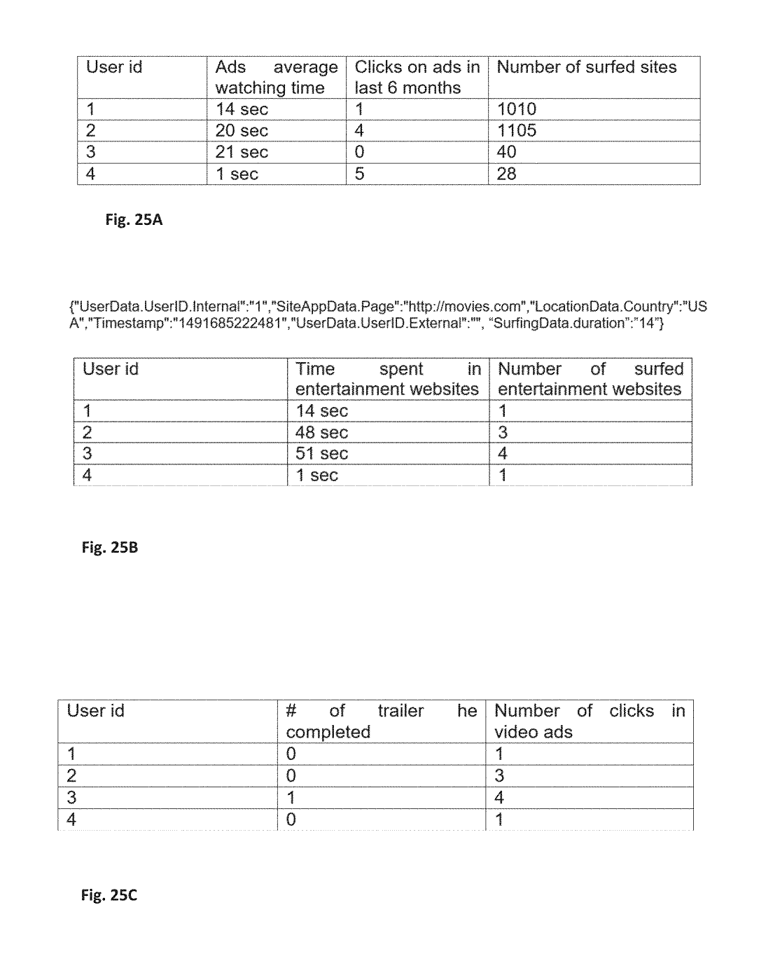

FIG. 10 is a flowchart showing the main steps of an exemplary process for Selection of tastes best representing the content item or title, executed by a content item prototypical tastes selection logic in accordance with some embodiments of the present invention;

FIG. 11 is a diagram associated with the process of Selection of tastes best representing the content item or title, in accordance with some embodiments of the present invention, showing a set of exemplary tastes, collectively constituting a semantic taste profile for the movie title ‘Girl on the Train’ (2016);

FIG. 12 is a block diagram showing an exemplary Segmentation Server and an Audience Segmentation Block thereof, in accordance with some embodiments of the present invention;

FIG. 13 is a flowchart showing the main steps of an exemplary process for Narrowing a set of audience members candidates, executed by a content items campaign candidates filtering logic, in accordance with some embodiments of the present invention;

FIGS. 14A-140 are diagrams associated with the process of Narrowing a set of audience members candidates, in accordance with some embodiments of the present invention, wherein: FIG. 14A shows an exemplary table listing the distances between each of the tastes of an exemplary user/member and two prototypical tastes; FIG. 14B shows an exemplary decision tree, demonstrating the user inclusion decision process of a given user to a genes assigned title; and FIG. 14C shows an exemplary decision tree, wherein received inputs from human experts who reviewed the tagged title, point out some additional genes;

FIG. 15 is a flowchart showing the main steps of an exemplary process for Calculating a rank of fitness for the selected candidates, executed by a content items campaign candidates rank calculator, in accordance with some embodiments of the present invention;

FIG. 16 is a diagram associated with the process of Calculating a rank of fitness for the selected candidates, in accordance with some embodiments of the present invention, showing an exemplary table of the distances calculated between user tastes and their closest title taste prototypes (i.e. broadened title tastes, thus comparable to user tastes, composed of representative users' tastes);

FIG. 17 is a flowchart showing the main steps of an exemplary process for Creating and populating campaign audience segments, executed by a taste-differentiated campaign segments generator, in accordance with some embodiments of the present invention;

FIGS. 18A-18C are diagrams associated with the process of Creating and populating campaign audience segments, in accordance with some embodiments of the present invention, wherein: FIG. 18A shows an exemplary diagram, showing a checking of whether new centroids are closer to a title taste other than the title taste they were previously closest to; FIG. 18B shows an exemplary diagram, showing the assigning of a user to a specific taste; and FIG. 18C shows an exemplary diagram, showing the moving of users from one taste to another;

FIG. 19 is a block diagram showing an exemplary Segmentation Server and an Audience Expansion Block thereof, in accordance with some embodiments of the present invention;

FIG. 20 is a flowchart showing the main steps of an exemplary process for Identification of audience segments with improvement potential and/or problematic audience segments situations, executed by an audience segments expansion analysis logic, in accordance with some embodiments of the present invention;

FIGS. 21A-21C are diagrams associated with the process of Identification of Identification of audience segments with improvement potential and/or problematic audience segments situations, in accordance with some embodiments of the present invention, in accordance with some embodiments of the present invention, wherein: FIG. 21A shows a table including exemplary segment results from previous audience segmentations/campaigns performed; FIG. 21B shows a diagram of an exemplary decision tree based on the segments results from previous audience segmentations/campaigns performed; and FIG. 21C shows a table of exemplary ‘new’ segments to which a decision tree was applied, along with the decision reached for each segment;

FIG. 22 is a flowchart showing the main steps of an exemplary process for Semantic audience segments expansion based on similar titles, executed by an audience segments semantic expansion logic, in accordance with some embodiments of the present invention;

FIGS. 23A-23B are diagrams associated with the process of Semantic audience segments expansion based on similar titles, in accordance with some embodiments of the present invention, wherein: FIG. 23A is a listing of exemplary genes mutually shared by by two titles; and FIG. 23B is a listing of exemplary tastes of a title similar to another title being audience segmented;

FIG. 24 is a flowchart showing the main steps of an exemplary process for Behavioral audience segments expansion based on browsing patterns, executed by a web/network surfing behavior based segments expansion logic, in accordance with some embodiments of the present invention; and

FIGS. 25A-25C are diagrams associated with the process of Behavioral audience segments expansion based on browsing patterns, in accordance with some embodiments of the present invention, wherein: FIG. 25A shows a table including a listing of exemplary users along with corresponding information associated with their website visits; FIG. 25B shows a web record and a table listing based thereof, showing exemplary users along with corresponding information associated with their website visits; and FIG. 25C shows a table listing exemplary additional user data from running previous campaign audience segmentations.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Throughout the specification and the following discussions:

The term ‘Genome’ may refer to a pre-defined structured taxonomy of media-specific content features/characteristics, structured in content categories, and degreed by salience scores and/or confidence measures; each such feature/characteristic is referred to as a ‘Gene’ hereinafter.

The term ‘User Profile(s)’, ‘User Taste Profile(s)’, ‘Semantic User Taste Profile(s)’, ‘Domain Specific Semantic User Taste Profile(s)’, or ‘Content Item Taste Profile(s), may refer to a set of user-specific, or content item/title specific, preference values, associated with characteristics of a specific domain, for example media content domain. A ‘User Taste Profile’, or ‘Content Item Taste Profile, may be structured as one or more clusters of vectors of semantic features from the Genome taxonomy and/or from additional sources of domain-related (e.g. entertainment-related) features, wherein each cluster may represent one taste of the given user. A ‘User Profile(s)’ may further include ‘non-taste features’ such as: general surfing habits (e.g. time spent watching clips and ads), and available personal data, to enrich the amounts and/or types of information in the profiles.

The term ‘Distance/Similarity’, or ‘Semantic Distance Similarity’, may refer to the result of a mathematical similarity function used to determine/estimate the level of similarity between tastes, for example, semantic user taste profiles and a profile of an advertising content title.

The term ‘Content’, and/or any other more specific content-describing terms such as ‘title’, ‘media’, ‘primary content’, ‘advertising content’, ‘ad item’, ‘secondary content’ or the like, is not to limit the scope of the associated teachings or features, all and any of which may refer and apply to any form of digital content known today, or to be devised in the future.

The above described terms—‘Genome’, ‘Gene’, ‘User Profile’/‘Semantic User Taste Profile(s)’, ‘Semantic Distance Similarity’ and/or ‘Content’—are further defined, exemplified and elaborated on, in applicant's U.S. patent application Ser. No. 12/859,248, U.S. patent application Ser. No. 13/872,115, U.S. Provisional Patent Application No. 62/333,291 and U.S. patent application Ser. No. 15/466,973, which applications are incorporated by reference hereto, in their entirety.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes methods, circuits, devices, systems and associated machine executable code for content targeting and delivery. According to some embodiments, there may be provided an automated system for targeting a specific content item towards a dynamically selected audience group, wherein the dynamically selected group is compiled based on receptiveness of group members to one or more attributes of the specific content item.

Content items may be representative of (e.g. advertisement for) an offering, such as content (e.g. a movie), a good, a service and/or a cause (e.g. Greenpeace). According to embodiments, several different content items may be representative of the same offering. Each of one or more content items, for the same or for different offerings, may be targeted towards a separate respective audience group, wherein a specific content item and a specific group may be matched based on an affinity of group members of the specific group towards attributes of the specific content item.

According to further embodiments of the present invention, the system may dynamically generate one or more audience groups, from a pool of potential audience members, by: (1) identifying a set of content attributes (e.g. in form of attribute vectors) of the content item; and (2) searching data records in a database of audience pool member records, which records include individual member targeting identifiers with associated content preferences (optionally in the form of a semantic taste profile, for example—as described in applicant's U.S. patent application Ser. No. 15/466,973, which is incorporated hereto by reference), for members whose content preferences match, correspond or otherwise correlate to as least some of the content item's content attributes.

According to some embodiments, multiple audience groups may be generated for a given content item with a substantially large set of content attributes, wherein each group is associated with a different combination of attributes.

The system according to some embodiments of the present invention may also deliver a content item to members of one or more audience groups matching the content item attributes, directly or through a third party network, using the member identifiers.

According to some embodiments, targeted content items may include: media/entertainment content—movies, TV shows and series, recorded/live shows, events and performances; trailers—movie trailers, TV trailers, previews, promos, sports/news updates; and/or advertisements—any promotional content, commercial content and/or content representative of an offering.

According to some embodiments, a given targeted secondary content item (e.g. a movie trailer), inherently associated with a corresponding primary content item (e.g. the movie of the trailer) may be targeted at least partially based on the matching of attributes of the primary content item to audience pool members' attributes.

According to some embodiments, targeted content items may be representative of an offering. Content items representing offerings may include: (1) trailers or previews, informing of and presenting to members of a targeted audience group, highlights or climaxes which are part of, or are associated with, another, primary, content item or set of content items (e.g. a movie, a TV series, a sports/cultural event) offering members of the targeted audience group to consume the primary content (e.g. visit cinema, watch TV series on Netflix, go to a football-game/live-show or watch it online); (2) advertisements or promotions, interesting members of a targeted audience group in specific goods, services and/or causes and offering/convincing members to: purchase, subscribe, donate/contribute and/or recommend or offer to others the goods, services and/or causes, represented in the offering of the content item(s).

According to some embodiments, targeted content items representative of an offering, may include a reference(s) for purchasing, renting or leasing the offering, for sharing the offering with others and/or for learning more about the offering being made. Reference(s) in a targeted content item representative of an offering may include: Internet or network links to producers, manufacturers, wholesalers, retailers, distributers or reviewers of the offering; and/or contact details, such as: phone numbers, addresses, email addresses and/or social network names and aliases associated with producers, manufacturers, wholesalers, retailers, distributers or reviewers of the offering.

According to some embodiments of the present invention, content item attributes may include a set of tastes representing the content item (title). The set of tastes representing the content item may be identified/generated by: (1) creating a repository of prototypical tastes based on key genes from existing taste profiles of a substantially large set of end users—wherein ‘genes’ are part of a ‘Genome’ consisting of a pre-defined structured taxonomy of domain-specific (e.g. media domain, entertainment domain) content features/characteristics, structured in categories (e.g. content categories), and degreed by salience scores and/or confidence measures, wherein each such feature/characteristic may be referred to as a ‘Gene’: (2) tagging the content item with genes by classifying it against a genome or a subset thereof; (3) ranking the matching level of genes of each, or each of a subset, of the prototypical tastes to genes of the tagged content items; and (4) selecting one or more highest scoring (best matching) tastes from the prototypical repository as the attributes of the content items.

According to some embodiments, members of an audience group for a given targeted content item may be selected from within an audience pool, at least partially based on the level of matching of the tastes included in each of the member's taste profiles, to the highest scoring (best matching) tastes selected as the given content item's attributes.

According to some embodiments, a content item, or content item version, representing an offering, may be selected from within a set of two or more content items/versions representing the same offering (e.g. different angles/attribute-sets/emphasis).

The levels of matching of tastes included in each, or in a subset, of the pool member's taste profiles, to the tastes selected as the content item's attributes, for each of the content items/versions representing the same offering, may be calculated. The levels of matching may be calculated by applying a semantic similarity/distance function between each taste of a user's taste profile and the tastes selected as the attributes of the content item (e.g. the advertised title), the function may take into account, at least: the confidence level of each taste, weights for different types of content categories, the salience of each gene in the given content item(s), the frequency of each gene in an entire content catalog, and/or relations between genes. A weighted aggregated score for the entire user's/pool-member's taste profile based on the similarity/distance between each taste of the user's/pool-member's taste profile and the profile of the advertised title.

Content item(s), content item(s) version(s) and/or content item(s) derivative(s), receiving the highest matching levels scores (e.g. overall, average) to pool member's taste profiles, or content items/versions which yielded the largest pool members group having matching tastes (appeals to the largest crowd segment), may be selected for representing the offering.

According to some embodiments, upon generation of a pool members group having a number of members which is below a predefined, or aspired, threshold number, the system may: (1) lower one or more matching level conditions for inclusion in the pool members group; and/or (2) while considering their relative relevance to different members groups—move members from a pool members group, having a number of members which is above the predefined threshold, into a relatively relevant pool members group also having a number of members which is below the predefined threshold.

Pool members group(s) having a specific aspired or predefined number—maximal, minimal, or range—of members, may be generated by tuning one or more matching level conditions for inclusion in the respective pool members group(s).

According to some embodiments, multiple content items, or content item versions, may be selected from within a set of two or more content items/versions representing the same offering (e.g. different angles/attribute-sets/emphasis), wherein: (1) each of the selected items/versions better matches a different member group from within the audience pool; and/or (2) each of the selected items/versions yields a substantially large audience pool member group and the yielded substantially large pool member groups are strange to, or only partially overlap, each other.

According to some embodiments, taste profiles of audience pool members may each be associated with a member identifier. A content item targeted towards a specific matching audience group may be forwarded/delivered, directly or through a third party network, to audience group members based on their corresponding identifiers in the audience pool, optionally retrieved as part of the audience group's generation.

Member identifiers may be, or may be associated/correlated with, one or more contact details of their respective member. Associated/correlated contact detail(s) (e.g. e-mail address, account name or credentials, SN name or alias) may be utilized by the system for forwarding/delivering a given matched content item to the specific member. The process may be repeated until the given matched content item is forwarded/delivered to all audience group members in its matching audience group.

A system in accordance with some embodiments, may facilitate ad-space bidding/pricing, wherein prices are set based on system computed matching level, or matching confidence, in the matching of a content-item (e.g. an ad), or attributes thereof, to taste profile attributes of specific users/members, user groups and user segments.

According to some embodiments, bids or offers for forwarding/delivering and presenting a given content item (e.g. an ad) at a specific location, for example a specific area of a given website's page, may be calculated at least partially based on the matching level of the attributes of the given content item to the attributes of taste profiles of pool members which: visited and/or are currently visiting the specific location; and/or had or are currently having engagement or interaction with data at the specific location.

The higher the matching level of the specific location associated pool members' attributes to the attributes of the given content item is, the higher the value of the bid or offer will be. Accordingly, multiple presentations of the same content item at different locations (e.g. web-places), websites, webpages, times, and/or to different users, may each trigger the generation of a corresponding differently priced bid.

A system in accordance with some embodiments, may facilitate customized content item generation for given/pre-defined/dynamically-generated targeted members groups. According to some embodiments, content items may consist of multiple segments (e.g. video trailer subdivisions), wherein for each of the multiple segments of a given content item, the system may store one or more alternatives each providing a different perspective and/or emphasis.

For each content item segment, the matching level of attributes of each of the segment alternatives to the attributes of taste profiles of a specific targeted members group may be computed. The process may be repeated for each of the segments collectively forming the content item.

A customized content item may be automatically generated, in accordance with some embodiments, wherein the generated content item consists of segment alternatives best (or highly) matching the specific targeted members group, for each or all of the segments collectively forming the content item.

According to some embodiments, multiple customized content item versions, each having a similar segment structure but including different alternative content item segment selections for at least some of their segments, may be automatically generated by the system for multiple respective socioeconomic given/pre-defined/dynamically-generated member groups.

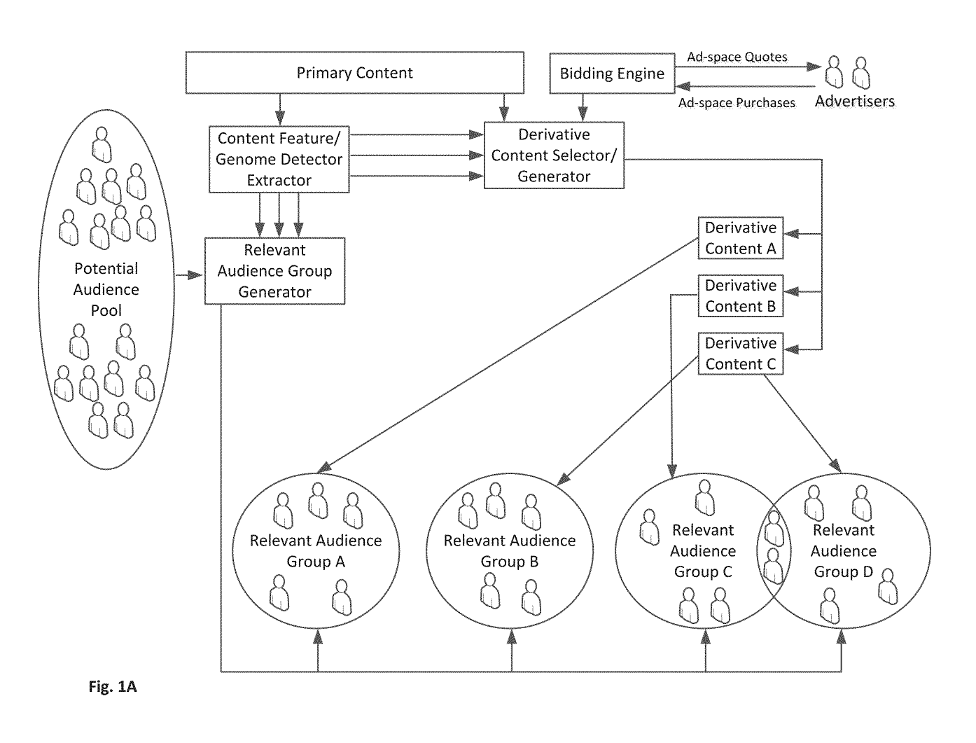

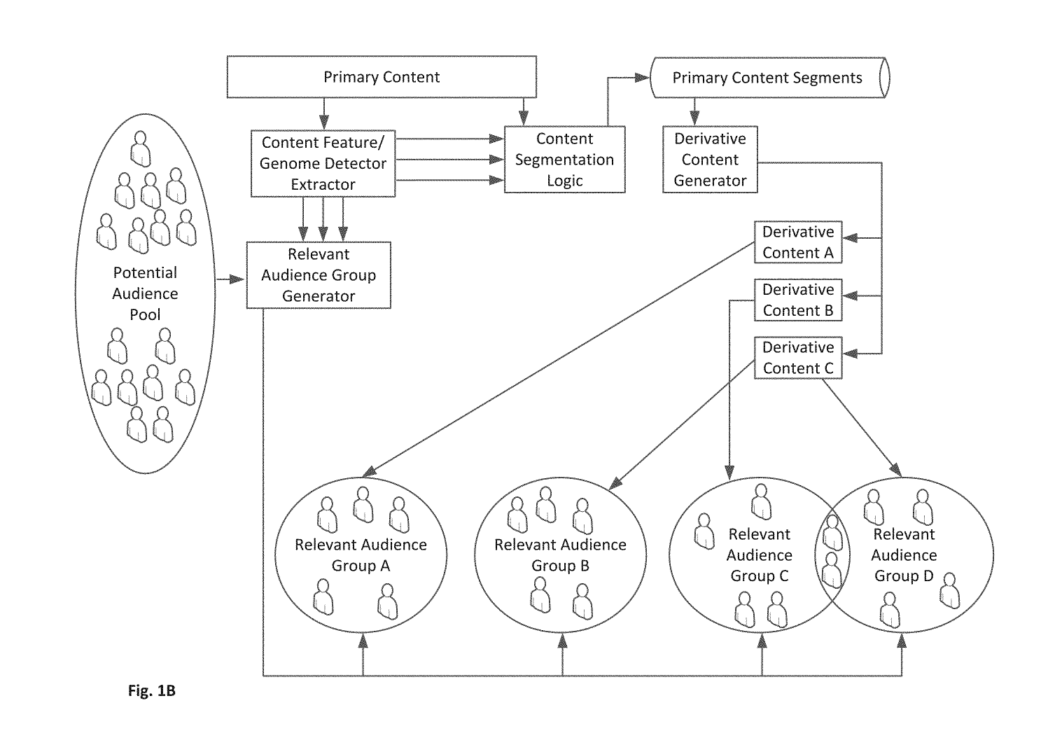

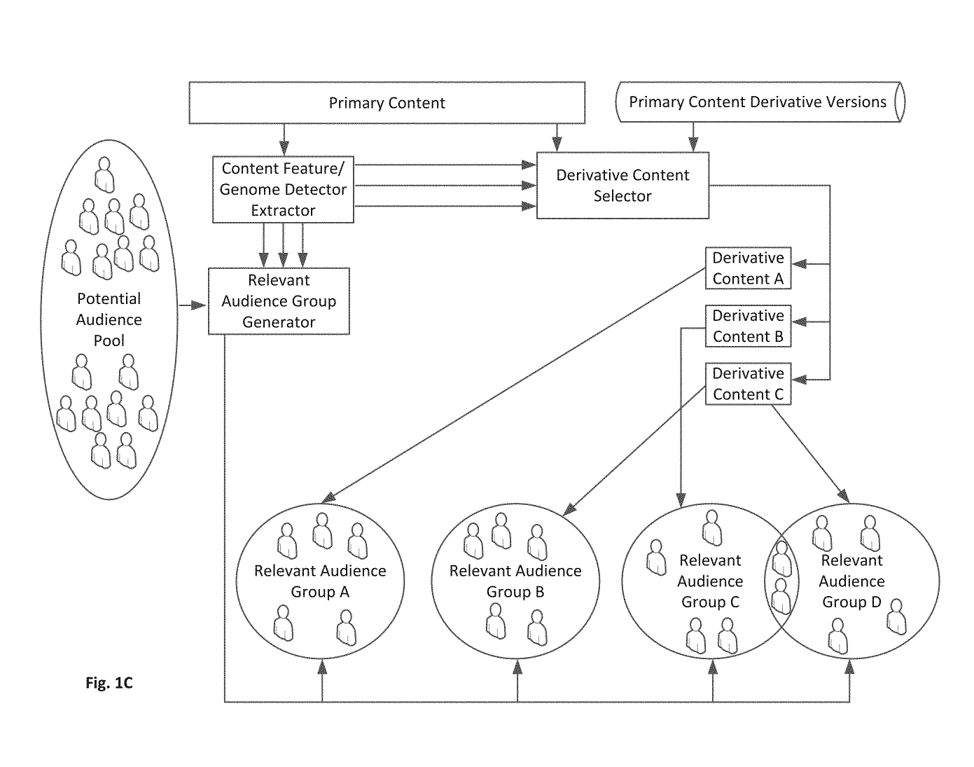

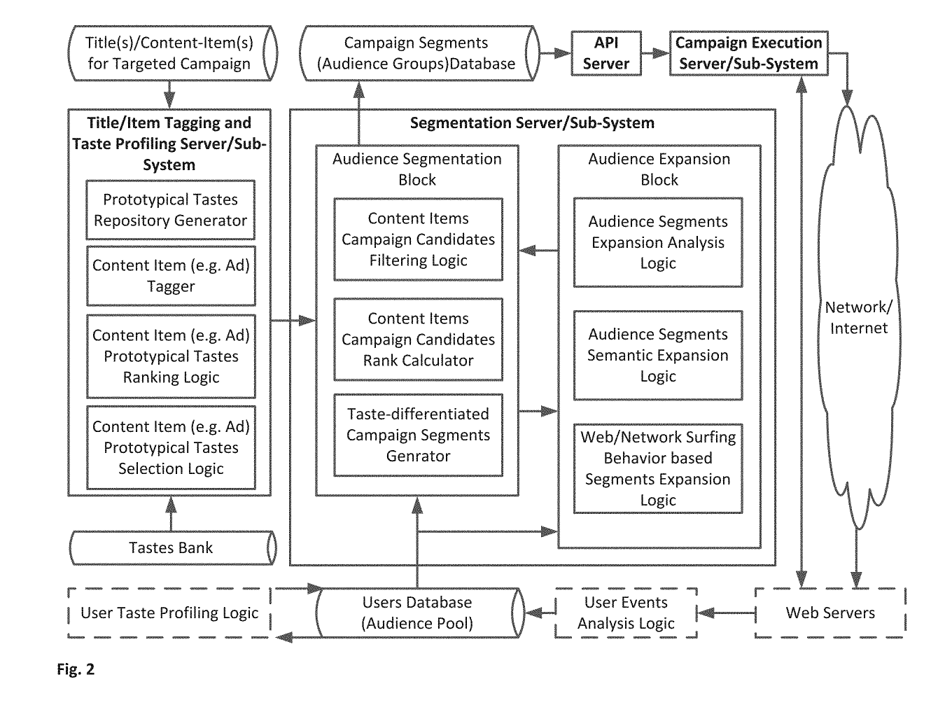

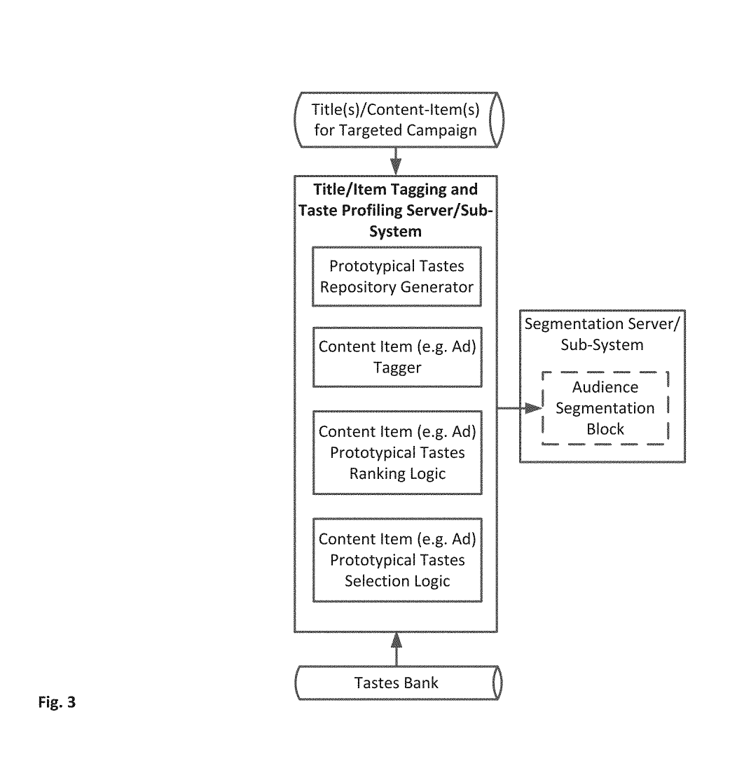

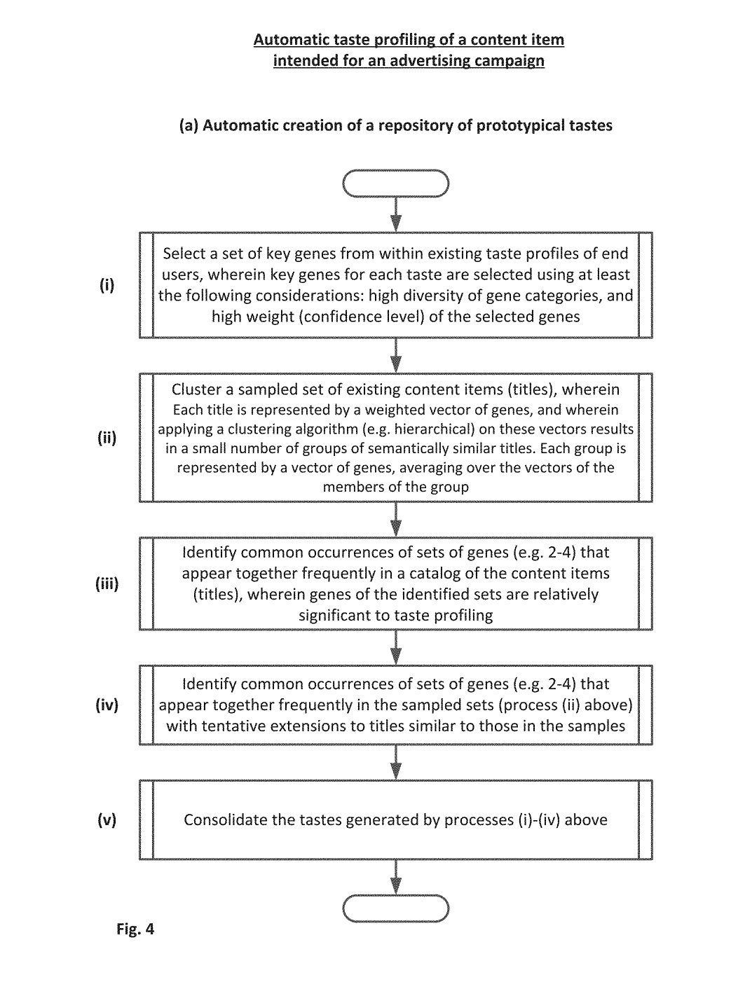

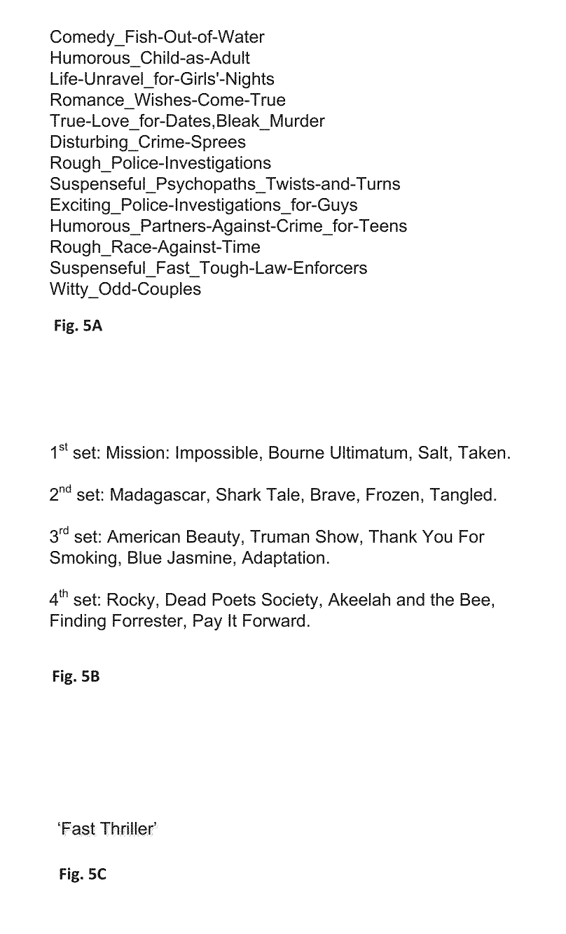

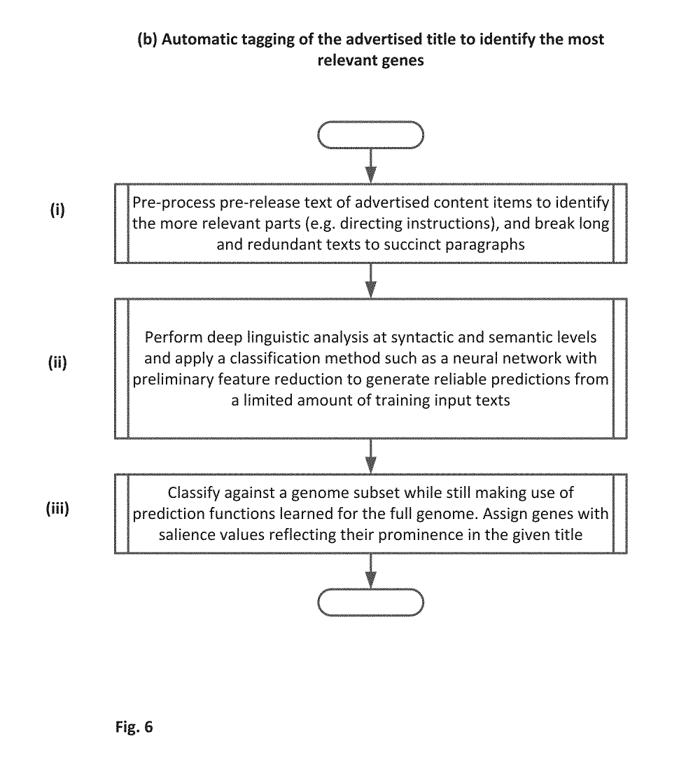

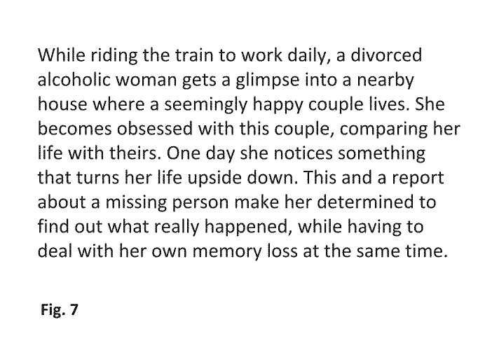

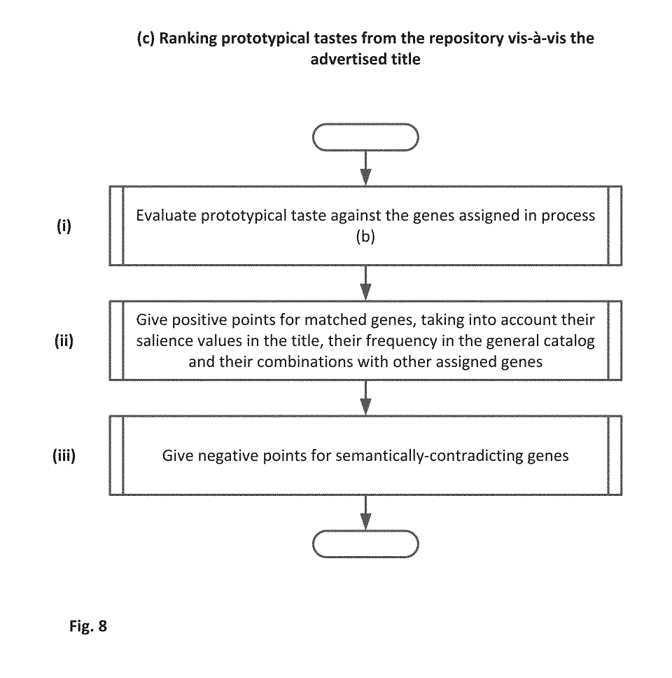

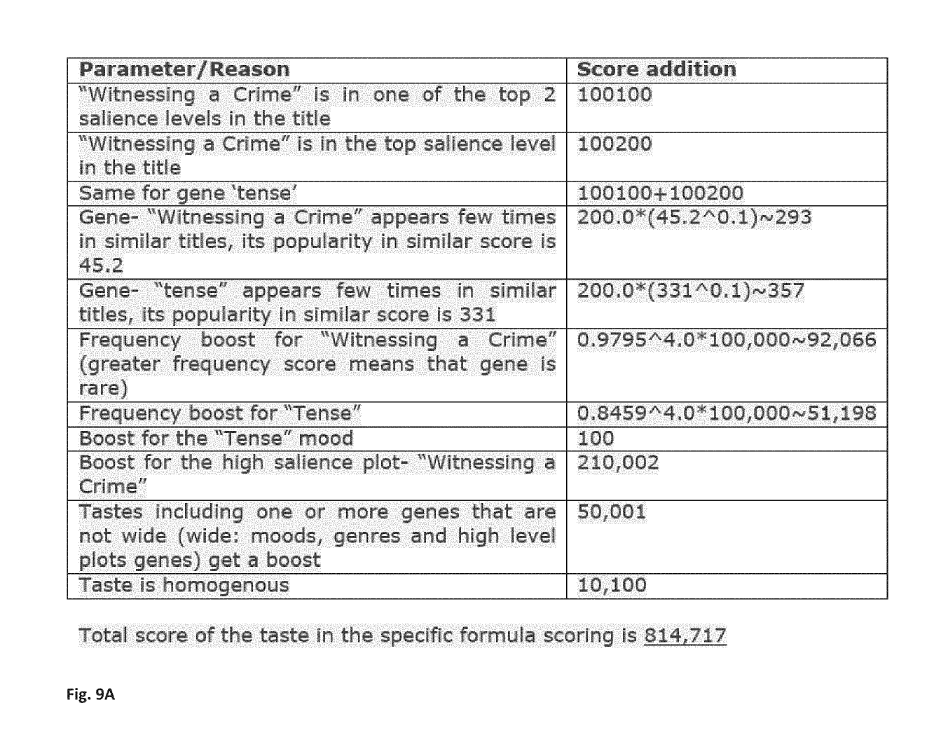

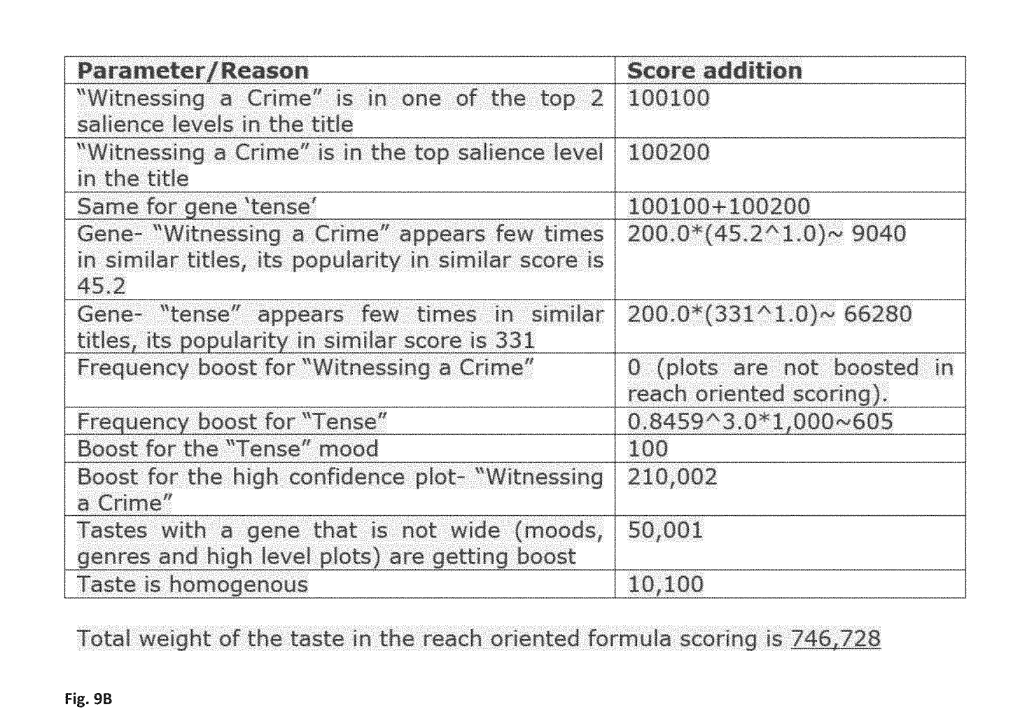

In FIG. 1A there is shown, a block diagram of an exemplary system for content item targeting and delivery, in accordance with some embodiments of the present invention. In the figure, the shown content feature/genome detector and extractor is adapted for exposing and identifying one or more attributes of a content item stored in the shown primary content data storage and intended for targeted delivery. Identified content item attributes are compared to attributes of one or more members of the shown potential audience pool and group(s) of matching members are accordingly defined by the relevant audience group generator shown. A derivative content selector/generator selects and/or generates one or more derivative content versions of the primary content, and delivers each of them to one or more corresponding relevant audience group(s): A, B, C and D in the figure. The relevant audience group(s) are generated to match the derivative content version(s) and/or the derivative content version(s) may be generated or selected to match predefined audience group(s). As demonstrated in the figure, a specific given derivative content may be delivered to multiple relevant audience groups and multiple relevant audience groups may have an overlap between them and thus include mutual audience members.

In FIG. 1B there is shown, a block diagram of an exemplary system for content item targeting and delivery including a derivative content generator. The derivative content generator generates derivative, audience group(s) matching, content versions, based on one or more content segments selected from within the shown primary content segments data storage and stitched together prior to delivery to members of the matching audience group(s). The derivative content generator combines/stiches selected segments of the primary content with generic/core content segments.

In FIG. 10 there is shown, a block diagram of an exemplary system for content item targeting and delivery including a derivative content selector. The derivative content selector selects derivative, audience group(s) matching, content versions, based on one or more available content versions selected from within the shown primary content derivative versions data storage and delivered to members of the matching audience group(s).

FIG. 2 is a block diagram showing in further details an exemplary system for content item targeting and delivery, including: servers, module blocks, logics and databases thereof. In the figure there is shown a title/item tagging and taste profiling server/sub-system for tagging content item(s)/title(s) stored in the shown title(s)/content-Item(s) for targeted campaign and for building taste profile(s) for the stored items/titles, based on prototypical tastes extracted from taste profiles of existing system users and stored to the shown taste bank data storage.

The shown audience segmentation block of the segmentation server/sub-system, builds audience member segments—matching the targeted content item or title to be delivered as part of a campaign—of users/members from within the shown user database (audience pool) and stores them the shown campaign segments (audience group) database.

The shown campaign execution server/sub-system runs the actual campaign, delivering the content-item/title and/or derivations thereof to members of the intended audience group. The campaign execution server/sub-system communicates with the segmentation server/sub-system via the shown application program interface (API) server, fetching the segmentation results from the campaign segments (audience group) database, as part of the campaign's execution. The campaign execution server/sub-system is shown to be connected to the web servers in the figure; and may actually ‘sit’ on top, or inside, the web server to deliver real-time bidding calls to the system.

The user taste profiling logic shown, builds semantic taste profiles for users in the users database (audience pool). The semantic taste profiles may be built at least partially based on outputs of the shown user events analysis logic based on user activity related data relayed by, or retrieved from, the web server(s). The semantic taste profiling of web and/or network users, including subsystems, components, elements, techniques and processes thereof, are described in applicant's U.S. patent application Ser. No. 15/466,973 incorporated by reference hereto.

The shown audience expansion block of the segmentation server/sub-system, expands audience member segments—matching the targeted content item or title to be delivered as part of a campaign—for example, of audience segments including a number of users/members below a given threshold—wherein segments expansion may be based on semantic and/or behavior expansion of existing segments.

The Web Servers (e.g. 3^{rd} party), User Events Analysis Logic and User Taste Profiling Logic—Shown in dotted lines—represent external components and functionalities associated with the present invention, for example, components and functionalities described in applicant's U.S. patent application Ser. No. 15/466,973, which is incorporated hereto by reference.

Various descriptions and examples of systems, processes and methods utilized for the generation of semantic user taste profiles similar to the user taste profiles mentioned and discussed herein, are provided in applicant's: U.S. Provisional Patent Application No. 62/333,291, U.S. patent application Ser. No. 12/859,248, U.S. patent application Ser. No. 13/872,115 and U.S. patent application Ser. No. 15/466,973, which applications are incorporated by reference in their entirety. The generated semantic user taste profiles may be used as part of the processes and examples described herein. Various additional descriptions and examples of systems, processes and methods utilized for measuring semantic similarity/distance between semantic user taste profiles and/or semantic content items taste profiles, are likewise provided in the above incorporated applications.

### (I) Automatic Taste Profiling of a Content Item Intended for an Advertising Campaign

According to some embodiments of the present invention, a Title Tagging and Taste Profiling Server may execute the following processes for automatically taste profiling a content item(s) intended for an advertising campaign.

A process for automatic taste profiling of a targeted content item, for example, a content item intended for an advertising campaign, may include: (a) Automatic creation of a repository of prototypical tastes; (b) Automatic tagging of the advertised title to expose and/or identify the most relevant genes; (c) Ranking prototypical tastes from the repository vis-à-vis the advertised title; and/or (d) Selection of tastes best representing the advertised title.

In FIG. 3 there is shown, in greater details, a Title Tagging and Taste Profiling Server comprising: (a) a Prototypical Tastes Repository Generator for automatic creation of a repository of prototypical tastes; (b) a Content Item Tagger for automatic tagging of the advertised title to expose and/or identify the most relevant genes; (c) a Content Item Prototypical Tastes Ranking Logic for ranking prototypical tastes from the repository vis-à-vis the advertised title; and/or (d) a Content Item Prototypical Tastes Selection Logic for selection of tastes best representing the advertised title.

### (a) Automatic Creation of a Repository of Prototypical Tastes

According to some embodiments, a set of appropriate tastes for a given new title may be selected from a repository of multiple (e.g. several thousands) common and diversified tastes, generated by one of the following procedures or combinations thereof: (i) Selection of a set of key (e.g. 2-4) taste representing genes, from each taste of end users using a content discovery and recommendation service (e.g. subject to user authorization), wherein key genes for each taste are selected using at least the following considerations: high diversity of gene categories, and high weight (confidence level) of the selected genes; (ii) Clustering of a sample of content items in the catalog of the content discovery and recommendation service, and generating short taste names—taste names that consist of a small set of key genes—for the clusters, wherein each title may be represented by a weighted vector of genes, and wherein applying a clustering algorithm (e.g. hierarchical) on these vectors may result in a small number of groups of semantically similar titles; each group may be represented by a vector of genes, averaging over the vectors of the members of the group; (iii) Searching for common occurrences of sets of key genes in the catalog and selection of dominant sets, having small sets of genes (e.g. 2-4) that appear together frequently in the catalog and that their categories (e.g. plot, mood) are relatively significant for taste profiling/modeling; wherein significance of a gene for taste profiling may be determined by its type (semantic category) and frequency in the catalog, frequency thresholds f1 and f2 may be defined such that a set of genes will be considered if all its genes appear together at least f1 times and/or any of its gene pairs appear together at least f2 times, optionally, the process may also involve rules defined by content experts; (iv) Searching for common occurrences of such sets in titles similar to those in the sample used in (ii), wherein frequency thresholds may be defined and used as in (ii) but appearance is calculated among the content items of the sample set and optionally also among some content items which are similar to any of the items in the sample set; and/or (v) Applying expert rules governing the acceptance of gene combinations to exclude problematic combinations, thus consolidating the tastes generated in steps (i)-(iv), and wherein consolidating may include: avoiding too similar of tastes, by utilizing an iterative algorithm, wherein in each iteration two similar tastes are examined and the one with more significant genes for taste profiling is kept while the other one is dropped (significance may be determined as in steps 3-4); and determining the internal order of genes in a taste, by using linguistic considerations so that the string of genes may look more natural in the target language (e.g. an adjective before a noun in English), and wherein grammatical inflections and conjunctions may be applied to create a natural taste name.

In FIG. 4, there is shown a flowchart describing the main steps executed as part of an exemplary process for automatic creation of a repository of prototypical tastes, in accordance with some embodiments of the present invention.

### Exemplary Embodiment—Automatic Creation of a Repository of Prototypical Tastes

a. A set of detailed semantic user taste profiles may be selected (e.g. arbitrarily, randomly) from within a Database of User Semantic Taste Profiles. Key genes may be selected from within each of the semantic user taste profiles, wherein the key genes are selected such as to collectively yield a set of genes having a high diversity of gene categories and a substantially high weight/confidence-level of each of the selected genes.
b. In FIG. 5A, there is shown an exemplary set of tastes, selected, from within semantic user taste profile(s).
c. A set of representative (category representative titles) content items (e.g. movie titles), may be communicated to the system and clustered into clusters of associated items (e.g. action movie titles, drama movie titles).
d. In FIG. 5B, there is shown an exemplary clustered set of movie title content-items, selected as described above and clustered by the system.
e. Each content item or title may be represented by a vector of genes. Each cluster of associated content items or titles may be represented as a vector averaging, or otherwise ‘normalizing’ (e.g. median, mode, mean, k-means algorithm [Iterative clustering and re-clustering]), the gene vectors of each of the content items or titles included within it. Substantially small set(s) of genes that appear together, beyond a threshold number of times, in the resulting clusters and/or respective vectors, may be added as prototypical tastes to the repository.
f. In FIG. 5C, there is shown an exemplary taste—‘Fast Thriller’—appearing with a relatively high level of confidence in the normalized/averaged vector representing titles from the first cluster shown in FIG. 5B (‘Mission: Impossible’, ‘Bourne Ultimatum’, etc.).
g. A list of specific genes considered of substantial importance and/or relevance to the construction of a content-item, or title, taste profile, may be communicated to the system. The communicated list may be intermittently, optionally dynamically and/or remotely, updated.
h. A list of specific genes considered important and relevant are communicated to the system. In response, the system may identify and select, from among the communicated genes, substantially small sets of genes having a tendency to appear together within multiple content items or titles. For example, the gene Mind-and-Soul has been found to often appear alongside the gene Parents-and-Children.
i. Sets of genes that appear together beyond a threshold number of times (e.g. more than 95% of the times), out of their total number (either together or not) of appearances, may be filtered out, or filtered out to only retain a single gene of the set, as they do not add much, or any, information over their alongside appearing counterparts—much like synonyms repeating, rather than adding on, each other. For example, the gene ‘Deadly’ and the gene ‘Killings’ both similarly inform, or indicate, of their associated content item or title, including the dying, passing-away or murder of a live creature(s).
   Accordingly, both a bottom threshold and a top threshold may be set, wherein genes that appear together, out of their total number of appearances, a percentage/number of times that is above the bottom threshold and below the top threshold, are selected and included and corresponding tastes are added to the repository.

### (b) Automatic Tagging of the Advertised Title to Identify the Most Relevant Genes

According to some embodiments, tagging may handle: synopses, reviews, scripts, screenplay outlines (“treatments”) and other pre-release texts of an advertised title, by (i) Pre-processing and identifying relevant parts (e.g. directing instructions and storylines), and breaking long and redundant texts to succinct paragraphs; (ii) Performing linguistic analysis at syntactic and semantic levels to extract potentially relevant linguistic features and applying a classification method, such as a neural network with preliminary feature reduction, to generate reliable predictions from a limited amount of training input texts; and (iii) Applying a classification procedure against a subset of a genome with utilization of prediction functions learned for the full genome, wherein assigned genes are given salience values reflecting their prominence in the given title.

In FIG. 6, there is shown a flowchart describing the main steps executed as part of an exemplary process for automatic tagging of the advertised title to identify the most relevant genes, in accordance with some embodiments of the present invention.

### Exemplary Embodiment—Automatic Tagging of the Advertised Title to Identify the Most Relevant Genes

a. According to some embodiments, hierarchical mapping may be employed to exploit the natural structure of the genome and to thus increase the accuracy of the tagging, i.e. mapping with certain genes, of content items. For example, the results of mapping a gene for high-level plot may be applied to the mapping of genes for particular themes. A gene mapper may adapt its rules and behavior according to the amount of free text, and/or number of free text items, available for each content item being tagged. The mapper may weigh the sources of textual information according to their past correlation with certain genes. For example, if a certain video reviewer has consistently written reviews that are a reliable source of theme genes, genes for themes from those reviews may be mapped with higher confidence. In some cases, a different weight may be given in training to genes whose mapping function performed poorly in the past.
   Operation of the gene mapper, may be based on a created, tuned and validated genome. Some manual gene mapping of sample content items may take place, to serve as a training set. The training set may be used to train the mapper and to create mapping logic for each gene. A genome and a training set are accordingly created and applied to train the gene mapping logic and mapping rules for various genes in the training set are generated.
b. The gene mapping logic and a feature extraction logic with components thereof may be embodied as logic in a computing environment. To obtain raw information for gene mapping, feature extraction may be performed by an extraction logic using linguistic analysis to extract linguistic features from textual sources such as content synopses and reviews (e.g. a web review of a new movie title).
c. In FIG. 7, there is shown an exemplary textual source—a movie title description utilized as one of the sources of linguistic features for gene mapping for the respective movie title, ‘Girl on the Train’ (2016). The linguistic analysis may involve: morphological normalization (stemming of words to base forms), syntactic parsing (e.g. detection of grammatical roles, syntactic relations and multi-word expressions) and semantic analysis (e.g. grouping of related terms as high-level concepts). The feature extraction logic may respectfully comprise: a morphology logic element, a syntax logic element and a semantic analysis logic element. Extracted linguistic features may be used as input to the mapping logic element, which may use statistical inference and mapping functions to map certain genes to the content.
d. A mapping of gene to content may involve: identifying the gene, giving the gene a score (quantifying its relevance to the content) and a confidence (quantifying how confident the mapper is in the relevance metric).
   The mapper may apply existing mapping rules for the genes and gene mappings from a previous step for the content item when forming a subsequent gene mapping. Applying previously-mapped genes for content to the mapping of subsequent genes for the content, or for other content, may be referred to herein as ‘cascaded classification’.

Various additional descriptions and elaborations, relating to content item tagging and/or gene mapping, including elements, operations and processes thereof, are provided in applicant's U.S. patent application Ser. No. 12/859,248 which is incorporated hereto by reference in its entirety.

(c) Ranking Prototypical Tastes from the Repository Vis-à-Vis the Advertised Title

According to some embodiments, (i) each prototypical taste may be evaluated against the genes assigned in process (b), wherein: (ii) Positive points may be given for matched genes, taking into account their salience values in the title, their frequency in the catalog and within combinations with other assigned genes; and (iii) Negative points may be given for semantically-contradicting genes.

In FIG. 8, there is shown a flowchart describing the main steps executed as part of an exemplary process for ranking prototypical tastes from the repository vis-à-vis the advertised title, in accordance with some embodiments of the present invention.

### Exemplary Embodiment—Ranking Prototypical Tastes from the Repository Vis-à-Vis the Advertised Title

a. According to some embodiments, genes assigned to a given content item title by the gene mapper may be compared to tastes in the created repository of prototypical tastes. Using a scoring function/formula, matching level rank(s)/score(s) may be calculated between each of some or all of the prototypical tastes in the repository and the genes mapped to the content item title. Based on the calculated matching scores, a subset of prototypical tastes, for which relatively high, or highest, matching scores were calculated, may be selected as to collectively form a taste profile for the given content item title.
b. According to some embodiments, formulas utilized to calculate title match scores of the prototypical tastes may give a higher weight and consideration to the selection of specific and more focused tastes for the title, or may give a higher weight and consideration to the selection of tastes that would, or are estimated to, supply a sufficient number of targeted audience members for the title to reach.
c. In FIG. 9A, there is shown a first exemplary matching score calculation, for calculating the matching level of the taste ‘Tense_Witnessing-a-Crime’ to the movie title ‘Girl on the Train’, utilizing a specific focused-tastes oriented formula. In the figure different exemplary parameters for scoring of the taste are listed, along with their respective scores and/or methods for calculation. The last line in the table gives a bonus score for homogenous titles—wherein each gene may be associated with a list of other conflicting genes. For example, a title including both Fiction and Documentary genes is considered non-homogenous (black lists of gene combinations).

d. In FIG. 9B, there is shown a second exemplary matching score calculation, for calculating the matching level of the taste ‘Tense_Witnessing-a-Crime’ to the movie title ‘Girl on the Train’, utilizing an audience members reach oriented formula. In the figure different exemplary parameters for scoring of the taste are listed, along with their respective scores and/or methods for calculation.
e. In the example, the taste ‘Tense_Witnessing-a-Crime’ received a lower score in the reach oriented formula scoring (FIG. 9B) than in the specific taste-focus oriented formula (FIG. 9A). In an alternative exemplary taste scoring scheme, starting with the reach oriented formula based selection of tastes and, than following with the focus oriented formula based selection of tastes, the taste ‘Tense_Witnessing-a-Crime’ may have only been selected at a later stage, as its ‘reach’ score is relatively low and may have prevented its pick as a first (i.e. highest scoring), or one of the first, selection. For example, using the reach oriented formula, another taste—‘Uncover-Truth_Thrillers’—has a greater score, 818,918 due to receiving high scores for its genes appearing in popular titles (93880 points for ‘Thrillers’ and 53960 for ‘Uncover-Truth’).
f. According to some embodiments, prototypical tastes may receive negative points to their rank/score, or may be completely filtered out from consideration as candidates for a given title. Tastes may be negatively ranked, or filtered out, due to their mismatch with tastes previously chosen for the title, for example, for containing one or more genes semantically contradicting genes in one or more of the previously chosen tastes.

Some or all of the following reasons, or any combination thereof, may cause a taste to receive negative points to its rank/score, or to be completely filtered out from consideration as candidate for a given title:
a. All, or a combination, of the following conditions are fulfilled:
   1. At least one of the taste genes is not from the genome of the title;
   2. Gene is: “audience”, “attitude”, “genre”, “style”, or “mood”; and
   3. A list of related genes (“family”) associated with an identified taste gene does not contain any gene from the genome.
b. At least one of the taste genes appears very few times in title(s) that are similar to the targeted content title.
c. Taste genes appear together in catalog very few times (e.g. memory-loss_cycling).
d. Two genes out of a three/two gene taste are not found in the title genome.
e. One gene tastes, when the gene is not from the title genome (e.g. Musicals).
f. Two gene tastes when one of them is not from the title genome and the other is not specific enough.
g. Two of the taste genes tend to appear together most of the times when one of them appears—in such cases two of the gene tastes look very similar and the taste becomes repetitive and/or non-informative (e.g. the high level plot Couples and the plot theme Couple Relations).
h. Two of the gene tastes were specifically configured as too similar for appearing together in a taste.
i. One of the taste genes was already chosen as a part of another taste.
j. One of the taste genes was configured specifically as forbidden when one of the chosen taste genes was previously selected.

### (d) Selection of Tastes Best Representing the Advertised Title

According to some embodiments, (i) a set of up to N tastes (e.g. 5) may be selected as representing the advertised title, by an iterative process which (ii) selects an advertised title, and takes at least the following parameters into account: (iii) The ranks calculated in process (c); (iv) The diversity, i.e. avoidance of too similar tastes for the same title; and (v) The expected amount of users following each taste (this data may be known only after target audience segments are created—see operation flow of the Population/Crowd/Audience Segmentation Logic hereinafter).

In FIG. 10, there is shown a flowchart, describing the main steps executed as part of an exemplary process for selection of tastes best representing the advertised title, in accordance with some embodiments of the present invention.

### Exemplary Embodiment—Selection of Tastes Best Representing the Advertised Title

a. In FIG. 11, there is shown, a set of exemplary tastes, collectively constituting a semantic taste profile for the movie title ‘Girl on the Train’ (2016), wherein listed tastes were extracted and selected based on movie title's descriptions (such as those shown in FIG. 11), by utilizing at least some of the elements, processes and techniques described herein.
b. The first two tastes listed in the figure, were selected/fetched using the scoring formula that gives a higher weight for making the tastes specific and more focused, whereas the last three tastes were selected/fetched using a reach oriented formula, giving high scores to tastes which are supposed to supply a sufficient amount of users. Tastes of the example in the figure were chosen iteratively, wherein the tastes with the best “specific score” were first selected and the tastes with the highest reach score were selected second.
c. According to some embodiments, once a given taste is chosen for a title, remaining additional taste candidates for the title may be checked, or rechecked, for their matching level to the added chosen taste. Mismatching candidate tastes and/or candidate tastes that consist of semantically contradicting genes may be punished by receiving negative points to their rank/score, or may be completely filtered out from consideration as candidates for the title.
   (II) Ranking Internet Users by Taste-Compatibility with the Content Item and Creating Target Audience Segments for the Campaign

According to some embodiments of the present invention, matching between profiled users and content item(s) intended for an advertising campaign and/or selecting the most appropriate candidates from a very large set of users and arranging them in “taste segments”, may include: filtering tentative candidates, calculating ranks of fitness for these candidates based on their tastes and the confidence level of each taste, defining audience segments in several levels of priority, and assigning users to segments in an optimized way.

According to some embodiments, an Audience Segmentation Server, or an Audience Segmentation Block thereof, may execute the following steps for ranking users (e.g. internet users) based on taste-compatibility with content item(s) and creating target audience segments for an advertising campaign.

a process for ranking users/pool-members by their taste-compatibility with a content item, for example, a content item intended for an advertising campaign and for creating target audience segments for the campaign, may include: (a) Narrowing the set of candidates; (b) Calculating a rank of fitness for the selected candidates; and (c) Creating and populating campaign audience segments.

In FIG. 12 there is shown, in greater details, an Audience Segmentation Block comprising: (a) a Content Items Campaign Candidates Filtering Logic for narrowing the set of candidates for targeted delivery of the content item; (b) a Content Items Campaign Candidates Rank Calculator for calculating a rank of fitness for the remaining non-filtered candidates; and (c) a Taste-differentiated Campaign Segments Generator Creating and populating campaign audience segments.

### (a) Narrowing the Set of Candidates

According to some embodiments, a decision tree may be applied for as a filter which decides who to include as a candidate target for the campaign and who to leave out. After (i) The advertised title is profiled; (ii) The decision tree may be generated and the correctness of the tree's structure may be examined by cross validation techniques; (iii) Expert rules concerning particularly important content features may be applied; and (iv) The decision tree may be utilized to decide who to include as a candidate target for a campaign, wherein decisions at nodes of the tree are based on the existence or nonexistence of a certain gene, and/or a certain set of genes, in any of the user tastes.

In FIG. 13, there is shown a flowchart describing the main steps executed as part of an exemplary process for narrowing the set of candidates, in accordance with some embodiments of the present invention.

### Exemplary Embodiment—Narrowing the Set of Candidates

Given the selected title tastes shown in FIG. 11, a training set of candidate users, which may consist of anywhere between few thousands and a few hundreds of thousands, may be generated. The generation of the training set may include the following steps:
a. Randomly selecting users/members from within a dataset/members-pool of users.
b. Calculating the distance between each of the selected users' tastes to each of the title taste prototypes (i.e. broadened title tastes, thus comparable to user tastes, composed of representative users' tastes)—an exemplary distance calculation is described hereinafter (in section (b) ‘calculating a rank of fitness for the selected candidates’).
c. Retrieving tastes of the selected users/members. For the following example, an exemplary user/member having two tastes ( . . . 0.2, 0.01, . . . , 0.2), ( . . . 0.15, 0.01, . . . , 0.31), have been selected.
d. In FIG. 14A, there is shown, a table listing the distances between each of the tastes of the exemplary user/member and each the prototypical tastes: Tense_Witnessing-a-Crime, Mysteries_Memory-Loss,
e. Receiving—optionally from content experts having access to examples of taste profiles and distance values—a threshold value (e.g. 0.3), such that when the distance between a given user/member taste and a given prototypical taste of the title is smaller than the threshold value, these tastes are considered close enough to each other.
f. In FIG. 14A the distance between the taste Mysteries_Memory-Loss and the user/member taste ( . . . 0.2, 0.01, . . . , 0.2) is smaller than the exemplary threshold of 0.3, accordingly the user/member, and/or his/her specific user taste, is considered as a positive example of a ‘close enough’ taste.
g. Utilizing one of the known in the art decision tree creation algorithm, a decision tree is generated and populated (e.g. a Classification And Regression Tree [CART]).
h. Using the decision tree to evaluate, each taste of each user, until—one of the following conditions is fulfilled:
   1. There is a positive decision for one of the user tastes (it is related to one of the title's prototypical tastes).
   2. No more tastes were left.

i. Determining a positive or negative decision in regard to each examined user, based on the tree supplied answers for the tastes of the user. For example: the tree designated at least one of the tastes of the user as positive (i.e. ‘close’ enough to one of the prototypical tastes assigned to the compared title).
j. In FIG. 14B, there is shown, an exemplary decision tree, demonstrating the user inclusion decision process of a given user to a title assigned with the genes ‘Witnessing a Crime’ and ‘Memory Loss’. With each negatively resulting comparison of a user taste to a title taste (i.e. distance between tastes is above threshold), the tree moves on to compare the next gene of the same specific title taste, upon a positively resulting comparison (i.e. distance between tastes is below threshold) a decision whether to include the user for the title is reached and the genes of tastes of the next user selected from the dataset/members-pool, are compared to the title.
k. In FIG. 14C, there is shown, an exemplary decision tree in accordance to some embodiments, wherein further received inputs (e.g. from human experts who reviewed the tagged title), point out some additional genes which they consider significant in that movie title. In the current example, the received inputs tell us that users lacking the gene ‘Alcohol Abuse’ are considered as irrelevant, or of low relevance, to the title. In the figure, the resulting tree following to an expert review is shown.
l. Tree quality, in accordance with some embodiments, may be measured by splitting the training set into two sets:
   1. Iteratively, a larger part (e.g. 80%) of the selected users/members will be considered as a training set and a smaller part (e.g. 20%) as cross validation set (e.g. 4000, 1000), average accuracy of the decision tree on the cross-validation set will be considered as the tree's score.
   2. For example, tree results on a first cross validation set are—300 were classified as related to the title, while 220 of them were found to actually be related. In addition, 700 (the remaining of the 1,000) were classified as not related to the title, but 40 of them were actually related. Accordingly, the accuracy of that cross validation set is (220+660)/1000=88%. Repeating the process for the next cross validation sets may, for example, result in accuracies of 89%, 93%, 80% and 85%. Finally, the average accuracy score is 87% (average of 88%, 89%, 93%, 80% and 85%).
m. The goal of the procedure of step l. above, is to choose the best parameters and/or the best algorithm to use for making the tree.

### (b) Calculating a Rank of Fitness for the Selected Candidates

According to some embodiments, ranking may be based on a semantic similarity between the user's tastes and the profile of the title, wherein a similarity function may be used to determine/estimate the level of the similarity between user tastes and a profile of a title. The process may include: (i) Deriving/retrieving users' tastes profiles and the profile of an advertised title composed from a small number of key genes with little or no internal redundancy; (ii) Applying dimension reduction techniques to improve performance; (iii) Applying a semantic similarity/distance function between each taste of a user's taste profile and the profile of the advertised title, while taking into account, at least: the confidence level of each taste, weights for different types of content categories, the salience of each gene in the given content items, the frequency of each gene in an entire content catalog, and/or relations between genes; (iv) Generating a weighted aggregated score for the entire user's taste profile based on the similarity/distance between each taste, or the closest user taste, of the user's taste profile and the profile of the advertised title (ii); and optionally (v) repeating steps (iii)-(iv) if additional taste profiles exist/remain.

According to some embodiments, user profiles may be extended with ‘non-taste features’ such as: general surfing habits (e.g. time spent watching clips and ads), and available personal data, to enrich the amounts and/or types of information in the profiles. The applied semantic similarity/distance function (step (iii) above) may take into consideration such ‘non-taste features’ in user profiles, as part of calculating similarity/distance between tastes of a user's taste profile and the profile of an advertised title.

In FIG. 15, there is shown a flowchart describing the main steps executed as part of an exemplary process for calculating a rank of fitness for the selected candidates, in accordance with some embodiments of the present invention.

### Exemplary Embodiment—Calculating a Rank of Fitness for the Selected Candidates

Given the narrowed set of candidates, a weighted score for each candidate's entire user taste profile is generated, based on the similarity/distance between each taste of the user's taste profile and the profile of the matched content item or advertised title. As part of the process, the structure gap between the ‘small’ (i.e. including a small number of genes) title tastes and the ‘bigger’ user taste profiles may be mitigated in order to allow for their comparison to each other and for calculation of their semantic similarity level.

The generation of the weighted scores may include the following steps:
a. Two possible types of inputs:
   1. Random users for building the training set of section (II)(a).
   2. Users who passed the procedure in section (II)(a) and are therefore considered potential candidates for being related to the title.
b. For each of the title tastes, a set (e.g. thousands) of users having one or more of the title's taste genes in their tastes will be fetched. For example, the user u(i) with the taste (0 . . . , 0.3, . . . , 0.41, . . . ), such that taste values for both ‘tense’ and ‘witnessing a crime’ are non-zeros—i.e. are present in the taste profile of the title.
c. User tastes with the highest confidence (confidence of the taste within the user's profile) that contains the title taste genes with high salience of the genes in relation to tastes of the examined user, will be considered as representative users for the title taste.
d. For example, the taste (0 . . . 0.1, . . . , 0.8, . . . , 0.82, . . . ) of user u has a confidence score of 0.7 such that the genes ‘tense’ and ‘witnessing a crime’ have salience values of 0.8 and 0.82 respectively.
e. For each of the title tastes, we construct from the user tastes “imported” from the user taste to the title taste, an average taste that will be considered as one of the title tastes—i.e. an expanded title taste comparable to ‘bigger’ user tastes.
f. For example, for the tastes (0 . . . 0.1, . . . , 0.8, . . . , 0.82, . . . ), (0 . . . , 0.81, . . . , 0.82, . . . 0.2, . . . ) with confidences of 0.7 and 0.6 respectively, an average vector of (0, . . . 0.05, . . . , 0.805, . . . 0.82, . . . 0.1, . . . ) is calculated.
g. Given a user with his/her taste profile, the distance between each of his/her tastes to each of the prototype tastes (i.e. broadened title tastes, thus comparable to user tastes, composed of representative users' tastes) of the title will be considered. For example, for the taste (0 . . . 0.1, . . . , 0.4, . . . , 0.33, . . . ) the distance to prototype taste (0, . . . 0.05, . . . , 0.805, . . . 0.82, . . . 0.1, . . . ) gave the value 0.23415, which may then be compared to the threshold value.
h. A weighted score will then be given to that user (only for users/candidates that passed the decision tree).
i. In FIG. 16, there is shown, an exemplary table of the distances calculated between user tastes and their closest title taste prototypes. In the example, the shortest (and thus most highly ranked) calculated semantic distance between a user taste and its closest title taste is the distance between the user taste T1 and the title taste ‘tense’_‘witnessing a crime’. A weighted score will be calculated, for example, by using the following formula:
   Output 0—if all distances are greater than the threshold (section (II)(a) step e.) considered as too far. Else, apply the following function, for all distances that are smaller than the threshold:

(1−best distance[lowest])*0.5+(1−distance( )*[1/(already found for the taste+1)]*0.1;
In our example (1−0.21)*0.5+(1−0.25)*(1/2)*0.1+(1−0.256)*1*0.1=0.5069
j. Result of the process are: a training set of tastes with a positive/negative decision for each (for input of step a.1 above); or a set of users that their weighted score is greater (i.e. shorter distanced) than the threshold determined by content experts (e.g., 0.411) (for input of step a.2 above).

### (c) Creating and Populating Taste-Differentiated Campaign Segments

According to some embodiments, campaign segments may correspond to the tastes composing the profile of the advertised title as created in section (I)(d) above. According to some embodiments, campaign segments may further correspond to different levels of confidence (e.g., high, medium and low). Priorities may be determined by the taste ranking procedure described there. What remains is to assign each selected user to one or more segments.

According to some embodiments, the following procedures or combinations thereof may be applied in case a single segment assignment is applied: (i) Looking for the segment achieving the highest value of a semantic similarity function between the title taste which corresponds to the segment and the user tastes; (ii) Selection of a few representative users for each campaign segment, calculating the midpoint of their taste vectors, measuring the distance of the user taste vectors to the midpoints and selecting the segment with the shortest distance; (iii) Balancing segment capacities by moving users from more populated segments to less populated ones based on the semantic distance between tastes (the distance function is the complement of the similarity function); and (iv) application of a clustering algorithm (K-means or another) to the whole audience or a sample thereof and creating a mapping between cluster centroids and title tastes, wherein the term ‘cluster centroids’, represent the mathematically calculated mid points of clusters.

According to some embodiments, wherein multiple segment assignment (e.g. an option which campaign managers may select) is performed, in steps (i) and (ii) above, a user may be assigned to all segments, or some of the segments, achieving a semantic similarity value at or above a given threshold (e.g. distance below a threshold).

In FIG. 17, there is shown a flowchart describing the main steps executed as part of an exemplary process for creating and populating campaign audience segments, in accordance with some embodiments of the present invention. In the figure a one segment per taste case is demonstrated, this simplified example is not to limit the teachings of the present invention from cases wherein: one to many, many to one and/or many to many—segment(s) to taste(s) correspondences, or to different levels or categories of correspondence confidence.

### Exemplary Embodiment—Creating and Populating Taste-Differentiated Campaign Segments

a. For each of the title tastes, one or more segments are created, for different tastes and confidence levels. For example, for the taste—‘Tense_witnessing-a-crime’ in the title ‘Girl on theTrain’, the segments:
   ‘Girl on theTrain’+Tense_witnessing_a_crime_HIGH;
   ‘Girl on theTrain’+Tense_witnessing_a_crime_MEDIUM; and
   ‘Girl on theTrain’+Tense_witnessing_a_crime_LOW. May be generated.
b. Given all user tastes for users that passed the threshold of section (II)(a) step e., a k-means clustering algorithm is activated (e.g. with k=amount of title tastes*1.5), each extended title taste is assigned to the closest cluster—this approach may help to better distribute the users in the different tastes, thus making the tastes better fitting to the specific title (e.g. by moving them slightly to title relevant directions).
c. In FIG. 18A, there is shown, an exemplary diagram, for iteratively assigning to each title taste, its closest free (e.g. unassigned) centroid. In an embodiment wherein each user is assigned to at most one taste, users will be assigned to the taste which fulfils the following conditions:
   1. One of the user's tastes was assigned (i.e. close enough—by threshold) to the taste's cluster.
   2. Taste confidence of that taste passes a predefined threshold (e.g., 0.3).
   3. Its score=TasteConfidence*(1-distance(taste,centroid)) is greater than all other legitimate candidates.
d. In FIG. 18B, there is shown, an exemplary diagram wherein user U1 is assigned to the taste ‘Mysteries_memory-loss’ since the confidence of T3 in the user taste is identical to that of T1 (0.23) but the distance from T3 to the centroid of Mysteries_memory-loss' is smaller than that of the ‘Missing-Persons_Strong-Female-Presence’ centroid to U1's T1.
e. According to some embodiments. an iterative balancing algorithm may be applied as follows:
   1. Tastes with very few users are marked, each with the total number of missing user tastes.
   2. In each iteration, a taste is chosen in a probability that reflects its relative lack of users (e.g. p=(missing users for the taste)/total missing users).
   3. For the selected taste, a bulk of relevant users (which fulfill 1, 2 [from the 3 conditions above excluding condition 3]) are moved to it (based on knowledge from section (II)(b) above).
   4. Users are moved to a taste if and only if, their original taste still has sufficient amount of users.
   5. Stop condition—when there are no more tastes with very few users, there are no users to move, or all users to move were already moved more than predetermined number of times (e.g. twice).
f. In FIG. 18C, there is shown, an exemplary diagram wherein users U1 and U2 were moved from ‘mysteries_memory-loss’ to ‘Missing-persons_strong-female-presence’ and Tense_witnessing_a-crime’, respectfully.
g. When segments with different levels of confidence are required, users of each taste are split to the different levels according to their distance from the centroid. (Aspired levels of confidence, the number of segments and/or the number of users in each segment, may be defined for the system, e.g. in the form of input parameters, prior to execution/running initiation).
h. The threshold of what may be considered “few” or “very few” (and sufficient), as well as segment associated parameters, may be determined in accordance with the specific campaign (e.g. by a campaign operations manager).

### (III) Expansion of Target Audiences Beyond the Initial Segments

According to some embodiments, audience segments (e.g. as calculated by the procedures described above) may, under certain conditions, not cover large enough audiences, and/or may suffer from over-targeting (i.e. many people in the segments will be obvious audience for whom the ad campaign will not have a significant added value). In such scenarios, certain algorithms may be utilized to expand, or contract, the target audiences while maintaining a reasonable “hit ratio”.

According to some embodiments, the Audience Segmentation Server, or an Audience Expansion Block thereof, may execute the following steps for expanding, previously created target audience segments for an advertising campaign.

a process for expansion of target audiences for a content item beyond the initial audience segments, for example, a content item intended for an advertising campaign, may include: (a) Identification of audience segments with improvement potential and/or problematic audience segments situations or problematic audience segments; (b) Semantic segment expansion and/or contraction based on similar titles; and (c) Behavioral expansion and/or contraction based on browsing patterns.

In FIG. 19 there is shown, in greater details, an Audience Expansion Block comprising: (a) an Audience Segments Expansion Analysis Logic for identification of audience segments with improvement potential; (b) an Audience Segments Semantic Expansion Logic for semantic segment expansion based on similar titles; and (c) a Web/Network Surfing Behavior Based Segments Expansion Logic for behavioral segment expansion based on browsing patterns.

(a) Identifying Audience Segments with Improvement Potential

According to some embodiments, an algorithm may consider audience segment sizes, diversity, and/or other parameters. The result may be used to determine if and to what extent expansion is required. According to some embodiments, the algorithm may include: (i) Retrieving previously executed campaign segments associated data; (ii) Extracting/calculating parameters such as segment size and segment diversity for at least part of the segments; (iii) Utilizing parameters from previously executed campaigns as training data set(s) for a machine learning process; and (iv) Utilizing ‘trained’ machine learning model (e.g. in the form of a decision tree wherein segment size, segments diversity and other parameters, define branches in the tree), and determine for a current campaign: whether, to which segments, and to what extent expansion is required, based on the extracted/calculated parameters.

System knowledge, for example from previous audience segmentations and/or content delivery campaigns, may allow for the improvement/upgrading/tuning of audience segments generated for a given title or content item.

In FIG. 20, there is shown a flowchart describing the main steps executed as part of an exemplary process for identifying audience segments with improvement potential, in accordance with some embodiments of the present invention.

### Exemplary Embodiment—Identifying Audience Segments with Improvement Potential

a. Identifying audience segments with improvement potential and/or problematic audience segments may include:
   1. Identify too narrow segments and expand them with more relevant users.
   2. Identify too wide tastes/segments and remove some of their users.
   3. Identify segments with high potential and expand them with more relevant users.
   4. Identify problematic segments and remove them. For example, problematic segments not handled in steps 1 or 2 above.
b. Segment diversity is defined as the average distance between users in that segment, wherein distance between users of a given segment is the distance between their ‘closest to the segment taste’ tastes.
c. In FIG. 21A, there is shown, a table including exemplary segment results from previous segmentations/campaigns.
d. Each of the segments is considered as a training example.
e. A class is assigned for each of the segments—based on their success in measuring and their segment size and diversity. Possible classes (quality definitions of segment) are: Problematic, Too diverse, Good segment and Too narrow.
f. Success measure/level of a segment is calculated as a weighted formula that summarizes few different measures, among them are the ratio of users that engaged with the title/content-item delivered to them, for example: users who clicked on an advertisement, or users who completed viewing the whole trailer although they had the ability/option to skip it.
g. The following is an example of such formula and/or of possible structures thereof.

((Number of users who watched at least half the time of the content/trailer and completed it)/(Number of users who watched at least half the time of the content/trailer and skipped))+((Total number of users who clicked the content/trailer clicks)/(Total number of users)).
h. Segments with high success score but small number of users and small diversity score will be considered as ‘too narrow’, similar segments with more users as ‘good’, segments with medium success score and reasonable number of users as ‘ok’, and wide segments containing many users, high diversity and low success score as ‘wide’.
i. In FIG. 21B, there is shown, a diagram of an exemplary decision tree created by utilizing a decision tree generation algorithm, based on the segments data in the table of FIG. 21A.
j. In FIG. 21C, there is shown, a table of exemplary ‘new’ segments (excluding a ‘segment success measure’) to which the decision tree of FIG. 21B was applied, along with the decision reached for each segment.
   In the figure, the segment—Tense_Witnessing-a-Crime—low fit—was classified as a ‘problematic segment’ and was therefore dropped.
   On the other hand, the segment—Missing-Persons_Strong-Female-Presence—high fit—was classified as ‘too narrow’—the system may accordingly attempt to add users to that segment and if impossible to add users (e.g. to many users already, no segment to move users from) to drop it as well. The segment may be dropped for one or more of the following possible reasons:
   1. It is more sensitive to mistakes in the algorithm—e.g. if these few users were selected by a special property and it is actually irrelevant.
   That is not the case for good tastes:
      i. decision tree could require low diversity threshold for being considered as good tastes.
      ii. even as in the figure, a segment with enough users can't be too narrow.
      iii. even if it is too narrow, we may want to retain it despite its weakness due to its advantage.
   2. Not enough users—it is better that relevant users will be moved to other tastes.
   The segment—Suspenseful_Alcohol-Abuse—high fit—was classified as ‘good’—the system may accordingly attempt to add users to that segment, but if impossible retain that segment nevertheless.
k. The procedure of adding users to a segment is similar to that in section (II)(c) step e. (balancing tastes).
l. When removing users is required, users which their closest taste has the highest distance to the segment's taste centroid will be initially removed.
m. The process of adding/removing users is done iteratively starting from the segments that users are removed from, then moving to the ‘too narrow’ segments and the adding of users (optionally—users just removed from ‘too wide’ segments) to them and finally handling the good tastes. Initially handling ‘too narrow’ segments may generate a larger set of later usable ‘good’ segments.
n. Addition of users may be terminated upon fulfillment of one, or both, of the following conditions:
   1. Segment classification decision of the tree has changed and no further expansion is needed.
   2. Removing further users from the adjacent segments may render them ‘problematic’ (e.g., with not enough users).

### (b) Semantic Expansion Based on Similar Titles

According to some embodiments, titles, substantially similar to the advertised title may be extracted from the catalog of the content discovery and recommendation service, using a semantic similarity function, for example as described in applicant's U.S. patent application Ser. No. 12/859,248 which is incorporated hereto by reference in its entirety.

Tastes for these titles may be calculated, audience segments generated for these tastes, and audience deltas thus calculated. According to some embodiments, the algorithm may include: (i) Extracting catalog titles similar to the advertised title; (ii) Calculating taste profiles for the extracted titles; (iii) Generating audience segments for the calculated tastes; and (iv) Calculating audience deltas—the differences between the audiences generated for titles similar to the advertised one and those generated for the advertised title itself—identifying audience overlaps and deducting them from the additions to be made to the original audience segments; and optionally, assigning users from audience deltas to the appropriate segments of the original title.

In FIG. 22, there is shown a flowchart describing the main steps executed as part of an exemplary process for semantic segment expansion based on similar titles, in accordance with some embodiments.

### Exemplary Embodiment—Semantic Expansion Based on Similar Titles

a. A title(s), semantically similar to the title for which the original audience segments were generated, is selected; in the present example the movie title ‘Before I Go to Sleep’ (2014) was selected. ‘Before I Go to Sleep’ was selected for its relatively high similarity to ‘Girl on the Train’ (2016) by applying a title-to-title similarity function as described herein and further elaborated on in applicant's previously filed applications incorporated by reference into the present application.
b. In FIG. 23A, there is shown, a listing of exemplary genes mutually shared by (exist within) the two titles.
c. The process is optionally repeated for additional semantically similar title(s)—creating, between each of the substantially similar titles and the immediate title(s), an audience overlap set and an audience set of optional members for addition (members not originally included in the audience segment for the immediate title).
d. In FIG. 23B, there is shown, a listing of exemplary tastes of the semantically similar title ‘Before I Go to Sleep’.
e. User/Audience segments are generated for the figure tastes of the title ‘Before I Go to Sleep’ listed in FIG. 23B.
f. Users that do not exist in the original, ‘Girl on the Train’ segments are added to its title segments, their appropriate tastes will be calculated as exemplified in section (II)(c) above for titles from step (II)(b).
g. Following to the addition of users from the similar title, revised segments may be reexamined and/or reclassified by the audience segments with improvement potential and/or problematic audience segments identification process of section (III)(a) above.

### (c) Behavioral Expansion Based on Surfing Patterns.

According to some embodiments, an analysis of users' internet behaviors, may indicate a potential interest in a campaign even if not associated with a particular taste segment. Substantially high values of the following parameters are among the indications that may be considered: (i) The level of interest in advertisements in general, particularly clicking and watching through, and the lack, or small number, of ad skipping and blockers installed/running; (ii) The amount of time devoted to watching clips (e.g. any clip type, specific type(s)); (iii) The amount of time spent in entertainment web sites; and/or (iv) The amount of time spent generally in web surfing. According to some embodiments, (v) A statistical analysis of observed vs. typical web surfing patterns may be executed as part of the audience expansion, wherein the purpose/focus may be (vi) Adding users having internet behaviors (e.g. browsing patterns) that may indicate a potential interest in the campaign even if not associated with a particular campaign taste segment, thus growing the audience segments.

In FIG. 24, there is shown a flowchart, describing the main steps executed as part of an exemplary process for behavioral segment expansion based on web/network surfing habits, in accordance with some embodiments of the present invention.

### Exemplary Embodiment—Behavioral Expansion Based on Surfing Patterns

a. In FIG. 25A, there is shown, a table including a listing of exemplary users along with corresponding information (e.g. supplied by a third party) associated with their website visits.
b. In FIG. 25B, there is shown, a web record and a table listing based thereof, showing exemplary users along with corresponding information associated with their website visits, collected based on their web/network behavior. Various web/network browsing/surfing user taste profiling techniques are described in applicant's U.S. patent application Ser. No. 15/466,973 incorporated by reference hereto.
c. In FIG. 25C, there is shown, a table listing additional user data from running previous campaign audience segmentations, as described herein. Each user was getting an entertainment score. In addition each user should have ads tolerance score (e.g., by using the formula—(time spent in entertainment websites-normalized to [0 . . . 1])*0.3+(average time in a trailer, normalized)*0.2+(clicks on ads normalized)*0.5). Using these measures may help in two areas:
   1. users with high entertainment/ads tolerance scores will be moved from low confidence segments to high confidence segments.
   2. users with high entertainment/ads tolerance scores will be added to segments in case budget for running a campaign remains but relevant user segments are fully used.

According to some embodiments of the present invention, a digital content targeting and delivery system may comprise: an interface to receive a primary content for distribution to one or more audience groups; a content feature detector to identify content features potentially relevant to one or more audience groups; a relevant audience set generator to parse a pool of potential audience member records into one or more (target) audience group lists by matching extracted content features with content preference parameters/fields within the potential audience member records, such that each member of an audience group shares at least one common content preference with a content preference detected in the primary content; and/or a derivative content delivery module to deliver to members of at least one audience group a derivative of the primary content including content segments with content features matching at least one preference of each of the members of the at least one audience group.

According to some embodiments, the derivative content delivery module may include a derivative content generator for generating, from within the primary content, segments with features appealing or relevant to a given audience group. The derivative content generator may combine and/or stich selected segments of the primary content with generic content segments. The derivative content generator may combine and/or stich relatively more content segments with features appealing/relevant to a given audience group than with generic segments. The derivative content generator may extend the relative number of content segments with features appealing/relevant to a given audience group in comparison to generic content segments.

According to some embodiments, the derivative content delivery module may include a derivative content selector for selecting derivative content with content segments having features appealing or relevant to a given audience group, from within a set of pre-generated versions of derivative contents.

According to some embodiments, the audience set generator, upon generation of an audience group list having a number of members which is below a predefined threshold, may lower the predefined threshold for inclusion in the audience group.

According to some embodiments, the audience set generator, upon generation of an audience group list having a number of members which is below a predefined threshold, may move into the audience group list having a number of members which is below a predefined threshold, members from another audience group list having a number of members which is above the predefined threshold.

According to some embodiments, the audience set generator may be adapted to adjust the audience group inclusion threshold, as to generate audience group lists including a predefined number of members. The predefined number of members may be selected from the group consisting of: a maximal number, a minimal number and a range of numbers.

According to some embodiments, the content feature detector (Title/Item Tagging and Taste Profiling Server) may comprise: a gene mapper (Content Item Tagger) for tagging the primary content item with relevant features (herein: genes) from a pre-defined structured taxonomy of domain-specific content features/characteristics structured in content categories (herein: genome); and/or a primary content item prototypical tastes ranking logic for ranking semantic tastes from a pre-generated repository of prototypical tastes against genes assigned to the primary content item by said gene mapper, wherein the semantic tastes from the repository are ranked at least partially based on their semantic similarity to semantic tastes of the primary content item, generated based on the genes assigned by said gene mapper. The content feature detector (Title/Item Tagging and Taste Profiling Server) may comprise a primary content item prototypical tastes selection logic for selecting from within the repository, a set of one or more relatively highly ranked prototypical tastes to collectively represent a semantic taste profile of the primary content Item.

The relevant audience set generator (Segmentation Server) may match the extracted content features with content preference parameters/fields within the potential audience member records, by: (1) applying a semantic similarity function between the semantic taste profile representing the primary content Item and semantic taste profiles of one or more potential audience members and/or (2) selecting one or more audience members, from within the potential audience member records, whose taste profiles are semantically most similar to the taste profile representing the primary content item.

According to some embodiments, a bidding engine may generate and provide ad-space price quotes, for presentation of the derivative content, wherein generated price quotes are at least partially based on the matching level between content features of the derivative content and preferences of each, or part, of the members of the targeted audience group.

According to some embodiments of the present invention, a digital content targeting and delivery method may comprise: receiving a primary content for distribution to one or more audience groups; detecting content features relevant to each of one or more audience groups; parsing a pool of potential audience member records into one or more (target) audience group lists by matching extracted content features with content preference parameters/fields within the potential audience member records, such that each member of an audience group shares at least one common content preference with a content preference detected in the primary content; and/or delivering to members of at least one audience group a derivative of the primary content including content segments with content features matching at least one preference of each of the members of the at least one audience group. Delivering the derivative content may include generating, from within the primary content, segments with features appealing/relevant to a given audience group.

According to some embodiments, the method may include stitching selected segments of the primary content with generic/core content segments, wherein relatively more content segments with features appealing/relevant to a given audience group than content segments with generic/core/non-relevant segments are selected and stitched.

According to some embodiments, delivering the derivative content may include selecting derivative content with content segments having features appealing/relevant to a given audience group, from within a set of pre-generated versions of derivative contents.

According to some embodiments, the method may include the moving, into an audience group list having a number of members which is below a predefined threshold, of members from another audience group list having a number of members which is above the predefined threshold.

According to some embodiments, detecting content features relevant to each of one or more audience groups may include: tagging the primary content item with relevant genes from a pre-defined structured taxonomy of domain-specific content features/characteristics structured in content categories; and/or ranking semantic tastes from a pre-generated repository of prototypical tastes against genes assigned to the primary content item, wherein the semantic tastes from the repository are ranked at least partially based on their semantic similarity to semantic tastes of the primary content item, generated based on the assigned genes.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A digital content targeting and delivery system comprising:
an interface to receive a primary content for distribution to one or more audience groups;
a content feature detector to identify content features potentially relevant to one or more audience groups;
a relevant audience set generator to parse a pool of potential audience member records into one or more (target) audience group lists by matching extracted content features with content preference parameters/fields within the potential audience member records, such that each member of an audience group shares at least one common content preference with a content preference detected in the primary content; and
a derivative content delivery module to deliver to members of at least one audience group a derivative of the primary content including content segments with content features matching at least one preference of each of the members of the at least one audience group.

2. The system according to claim 1, wherein said derivative content delivery module includes a derivative content generator for generating, from within the primary content, segments with features appealing or relevant to a given audience group.

3. The system according to claim 2, wherein said derivative content generator stiches selected segments of the primary content with generic content segments.

4. The system according to claim 3, wherein said derivative content generator combines/stiches relatively more content segments with features appealing/relevant to a given audience group than with generic segments.

5. The system according to claim 4, wherein said derivative content generator extends the relative number of content segments with features appealing/relevant to a given audience group in comparison to generic content segments.

6. The system according to claim 1, wherein said derivative content delivery module includes a derivative content selector for selecting derivative content with content segments having features appealing or relevant to a given audience group, from within a set of pre-generated versions of derivative contents.

7. The system according to claim 1, wherein said audience set generator, upon generation of an audience group list having a number of members which is below a predefined threshold, lowers the predefined threshold for inclusion in the audience group.

8. The system according to claim 1, wherein said audience set generator, upon generation of an audience group list having a number of members which is below a predefined threshold, moves into the audience group list having a number of members which is below a predefined threshold, members from another audience group list having a number of members which is above the predefined threshold.

9. The system according to claim 1, wherein said audience set generator is adapted to adjust the audience group inclusion threshold, as to generate audience group lists including a predefined number of members.

10. The system according to claim 9, wherein the predefined number of members is selected from the group consisting of: a maximal number, a minimal number and a range of numbers.

11. The system according to claim 1, wherein said content feature detector (Title/Item Tagging and Taste Profiling Server) comprises:
a gene mapper (Content Item Tagger) for tagging the primary content item with relevant features (herein: genes) from a pre-defined structured taxonomy of domain-specific content features/characteristics structured in content categories (herein: genome); and
a primary content item prototypical tastes ranking logic for ranking semantic tastes from a pre-generated repository of prototypical tastes against genes assigned to the primary content item by said gene mapper, wherein the semantic tastes from the repository are ranked at least partially based on their semantic similarity to semantic tastes of the primary content item, generated based on the genes assigned by said gene mapper.

12. The system according to claim 11, wherein said content feature detector (Title/Item Tagging and Taste Profiling Server) further comprises a primary content item prototypical tastes selection logic for selecting from within the repository, a set of one or more relatively highly ranked prototypical tastes to collectively represent a semantic taste profile of the primary content Item.

13. The system according to claim 12, wherein said relevant audience set generator (Segmentation Server) matches the extracted content features with content preference parameters/fields within the potential audience member records, by: (1) applying a semantic similarity function between the semantic taste profile representing the primary content Item and semantic taste profiles of one or more potential audience members and (2) selecting one or more audience members, from within the potential audience member records, whose taste profiles are semantically most similar to the taste profile representing the primary content item.

14. The system according to claim 1, further comprising a bidding engine for generating and providing ad-space price quotes, for presentation of the derivative content, wherein generated price quotes are at least partially based on the matching level between content features of the derivative content and preferences of each of the members of the targeted audience group.

15. A digital content targeting and delivery method comprising:
receiving a primary content for distribution to one or more audience groups;
detecting content features relevant to each of one or more audience groups;
parsing a pool of potential audience member records into one or more (target) audience group lists by matching extracted content features with content preference parameters/fields within the potential audience member records, such that each member of an audience group shares at least one common content preference with a content preference detected in the primary content; and
delivering to members of at least one audience group a derivative of the primary content including content segments with content features matching at least one preference of each of the members of the at least one audience group.

16. The method according to claim 15, wherein delivering the derivative content includes generating, from within the primary content, segments with features appealing/relevant to a given audience group.

17. The method according to claim 16, further including stitching selected segments of the primary content with generic/core content segments, wherein relatively more content segments with features appealing/relevant to a given audience group than content segments with generic/core/non-relevant segments are selected and stitched.

18. The method according to claim 15, wherein delivering the derivative content includes selecting derivative content with content segments having features appealing/relevant to a given audience group, from within a set of pre-generated versions of derivative contents.

19. The method according to claim 15, further including moving into an audience group list having a number of members which is below a predefined threshold, members from another audience group list having a number of members which is above the predefined threshold.

20. The method according to claim 15, wherein detecting content features relevant to each of one or more audience groups includes:
tagging the primary content item with relevant genes from a pre-defined structured taxonomy of domain-specific content features/characteristics structured in content categories; and
ranking semantic tastes from a pre-generated repository of prototypical tastes against genes assigned to the primary content item, wherein the semantic tastes from the repository are ranked at least partially based on their semantic similarity to semantic tastes of the primary content item, generated based on the assigned genes.
